(19) United States
(12) Patent Application Publication
(10) Pub. No.: US 2024/0022347 A1
(43) Pub. Date: Jan. 18, 2024

(54) APPARATUS, SYSTEM, AND METHOD OF COMMUNICATING UNEQUAL MODULATION AND CODING SCHEME (MCS) (UEM) INFORMATION

(71) Applicants: Hao Song, Santa Clara, CA (US); Qinghua Li, San Ramon, CA (US); Shlomi Vituri, Tel Aviv (IL); Thomas J. Kenney, Portland, OR (US); Robert Stacey, Portland, OR (US)

(72) Inventors: Hao Song, Santa Clara, CA (US); Qinghua Li, San Ramon, CA (US); Shlomi Vituri, Tel Aviv (IL); Thomas J. Kenney, Portland, OR (US); Robert Stacey, Portland, OR (US)

(21) Appl. No.: 18/477,606

(22) Filed: Sep. 29, 2023

(51) Int. Cl. H04L 1/00; H04B 7/0452

(52) U.S. Cl. CPC H04L 1/0003; H04L 1/0009; H04B 7/0452

(57) ABSTRACT

For example, an Access Point (AP) may be configured to set a user specific field in a Signal (SIG) field. For example, the user specific field may be configured for a user of a plurality of users in a Multi-User (MU) Multiple-Input-Multiple-Output (MIMO) (MU-MIMO) allocation. For example, the user specific field for the user may include an Unequal Modulation and Coding Scheme (MCS) (UEM) information subfield configured to indicate an assignment of a plurality of MCSs for the user. For example, the user specific field for the user may include a spatial configuration subfield configured to indicate a number of spatial streams for the user and a total number of spatial streams in the MU-MIMO allocation. For example, the AP may be configured to transmit a Physical layer (PHY) Protocol Data Unit (PPDU) including the SIG field.

### BACKGROUND

Devices in a wireless communication system may be configured to communicate according to communication protocols, which may utilize a Modulation and Coding Scheme (MCS).

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of a user specific field format, in accordance with some demonstrative aspects.

FIG. 3 is a schematic illustration of a user specific field format, in accordance with some demonstrative aspects.

FIG. 4 is a schematic illustration of a user specific field format, in accordance with some demonstrative aspects.

FIG. 5 is a schematic illustration of a user specific field format, in accordance with some demonstrative aspects.

FIG. 6 is a schematic illustration of a user specific field format, in accordance with some demonstrative aspects.

FIG. 7 is a schematic flow-chart illustration of a method of communicating Unequal Modulation and Coding Scheme (MCS) (UEM) information, in accordance with some demonstrative aspects.

FIG. 8 is a schematic flow-chart illustration of a method of communicating UEM information, in accordance with some demonstrative aspects.

FIG. 9 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications, December, 2020); and/or IEEE 802.11be (IEEE P802.11be/D4.0 Draft Standard for Information technology— Telecommunications and information exchange between systems Local and metropolitan area networks— Specific requirements; Part 11: Wireless LAN Medium Access Control (MAC) and Physical Layer (PHY) Specifications; Amendment 8: Enhancements for extremely high throughput (EHT), July 2023)) and/or future versions and/or derivatives thereof, devices and/or networks operating in accordance with existing cellular specifications and/or protocols, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated or group), and/or memory (shared, dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 Ghz and 300 GHz, for example, a frequency band above 45 GHz, e.g., a 60 GHz frequency band, and/or any other mmWave frequency band. Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (S1G) band, a WLAN frequency band, a WPAN frequency band, and the like.

Some demonstrative aspects may be implemented by an mmWave STA (mSTA), which may include for example, a STA having a radio transmitter, which is capable of operating on a channel that is within the mmWave frequency band. In one example, mmWave communications may involve one or more directional links to communicate at a rate of multiple gigabits per second, for example, at least 1 Gigabit per second, e.g., at least 7 Gigabit per second, at least 30 Gigabit per second, or any other rate.

In some demonstrative aspects, the mmWave STA may include a Directional Multi-Gigabit (DMG) STA, which may be configured to communicate over a DMG frequency band. For example, the DMG band may include a frequency band wherein the channel starting frequency is above 45 GHz.

In some demonstrative aspects, the mmWave STA may include an Enhanced DMG (EDMG) STA, which may be configured to implement one or more mechanisms, which may be configured to enable Single User (SU) and/or Multi-User (MU) communication of Downlink (DL) and/or Uplink frames (UL) using a MIMO scheme. For example, the EDMG STA may be configured to implement one or more channel bonding mechanisms, which may, for example, support communication over a channel bandwidth (BW) (also referred to as a “wide channel”, an “EDMG channel”, or a “bonded channel”) including two or more channels, e.g., two or more 2.16 GHz channels. For example, the channel bonding mechanisms may include, for example, a mechanism and/or an operation whereby two or more channels, e.g., 2.16 GHz channels, can be combined, e.g., for a higher bandwidth of packet transmission, for example, to enable achieving higher data rates, e.g., when compared to transmissions over a single channel. Some demonstrative aspects are described herein with respect to communication over a channel BW including two or more 2.16 GHz channels, however other aspects may be implemented with respect to communications over a channel bandwidth, e.g., a “wide” channel, including or formed by any other number of two or more channels, for example, an aggregated channel including an aggregation of two or more channels. For example, the EDMG STA may be configured to implement one or more channel bonding mechanisms, which may, for example, support an increased channel bandwidth, for example, a channel BW of 4.32 GHz, a channel BW of 6.48 GHz, a channel BW of 8.64 GHz, and/or any other additional or alternative channel BW. The EDMG STA may perform other additional or alternative functionality.

In other aspects, the mmWave STA may include any other type of STA and/or may perform other additional or alternative functionality. Other aspects may be implemented by any other apparatus, device and/or station.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

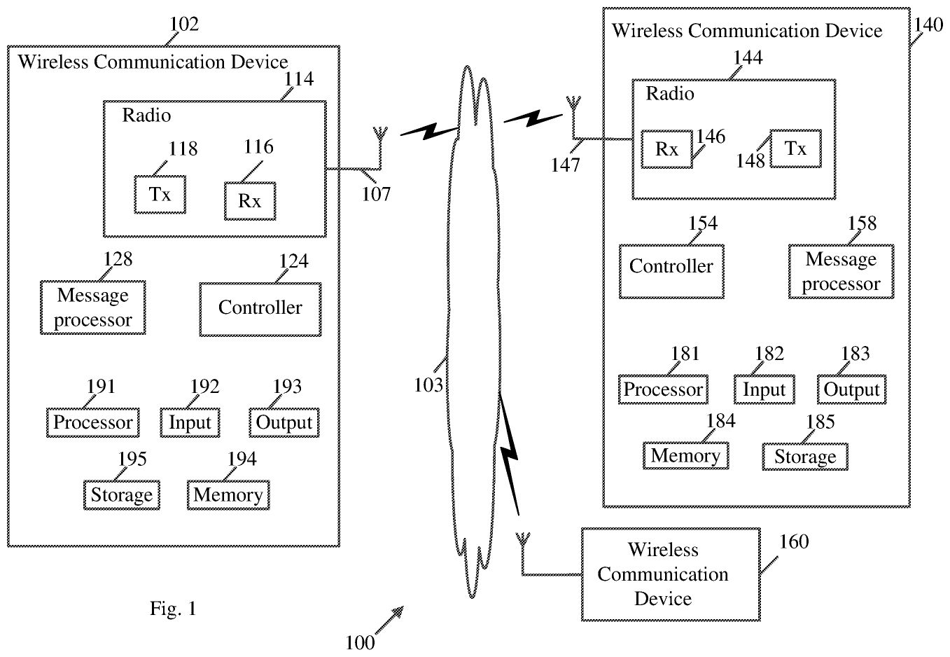

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, a wireless communication device 160, and/or one more other devices.

In some demonstrative aspects, devices 102, 140, and/or 160 may include a mobile device or a non-mobile, e.g., a static, device.

For example, devices 102, 140, and/or 160 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player or the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an Operating System (OS) of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a disk drive, a solid-state drive (SSD), and/or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102, 140, and/or 160 may be capable of communicating content, data, information and/or signals via a wireless medium (WM) 103. In some demonstrative aspects, wireless medium 103 may include, for example, a radio channel, an RF channel, a WiFi channel, a cellular channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 Ghz wireless communication frequency band, for example, a 2.4 GHz wireless communication frequency band, one or more channels in a 5 GHz wireless communication frequency band, and/or one or more channels in a 6 GHz wireless communication frequency band. In another example, WM 103 may additionally or alternatively include one or more channels in an mmWave wireless communication frequency band. In other aspects, WM 103 may include any other type of channel over any other frequency band.

In some demonstrative aspects, device 102, device 140, and/or device 160 may include one or more radios including circuitry and/or logic to perform wireless communication between devices 102, 140, 160, and/or one or more other wireless communication devices. For example, device 102 may include one or more radios 114, and/or device 140 may include one or more radios 144.

In some demonstrative aspects, radios 114 and/or radios 144 may include one or more wireless receivers (Rx) including circuitry and/or logic to receive wireless communication signals, RF signals, frames, blocks, transmission streams, packets, messages, data items, and/or data. For example, a radio 114 may include at least one receiver 116, and/or a radio 144 may include at least one receiver 146.

In some demonstrative aspects, radios 114 and/or 144 may include one or more wireless transmitters (Tx) including circuitry and/or logic to transmit wireless communication signals, RF signals, frames, blocks, transmission streams, packets, messages, data items, and/or data. For example, a radio 114 may include at least one transmitter 118, and/or a radio 144 may include at least one transmitter 148.

In some demonstrative aspects, radios 114 and/or 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radios 114 and/or 144 may include or may be implemented as part of a wireless Network Interface Card (NIC), and the like.

In some demonstrative aspects, radios 114 and/or 144 may be configured to communicate over a 2.4 GHz band, a 5 GHz band, a 6 GHz band, and/or any other band, for example, a directional band, e.g., an mmWave band, a 5G band, an S1G band, and/or any other band.

In some demonstrative aspects, radios 114 and/or 144 may include, or may be associated with one or more antennas.

In some demonstrative aspects, device 102 may include one or more antennas 107, and/or device 140 may include on or more antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140, 160 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140, 160 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or more messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of one or more radios 114. For example, the chip or SoC may include one or more elements of controller 124, one or more elements of message processor 128, and/or one or more elements of one or more radios 114. In one example, controller 124, message processor 128, and one or more radios 114 may be implemented as part of the chip or SoC.

In other aspects, controller 124, message processor 128 and/or one or more radios 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of one or more radios 144. For example, the chip or SoC may include one or more elements of controller 154, one or more elements of message processor 158, and/or one or more elements of one or more radios 144. In one example, controller 154, message processor 158, and one or more radios 144 may be implemented as part of the chip or SoC.

In other aspects, controller 154, message processor 158 and/or one or more radios 144 may be implemented by one or more additional or alternative elements of device 140.

In some demonstrative aspects, device 102, device 140, and/or device 160 may include, operate as, perform the role of, and/or perform one or more functionalities of, one or more STAs. For example, device 102 may include at least one STA, device 140 may include at least one STA, and/or device 160 may include at least one STA.

In some demonstrative aspects, device 102, device 140, and/or device 160 may include, operate as, perform the role of, and/or perform one or more functionalities of, one or more Extremely High Throughput (EHT) STAs. For example, device 102 may include, operate as, perform the role of, and/or perform one or more functionalities of, one or more EHT STAs, and/or device 140 may include, operate as, perform the role of, and/or perform one or more functionalities of, one or more EHT STAs.

In some demonstrative aspects, for example, device 102, device 140, and/or device 160 may be configured to perform one or more operations, and/or functionalities of a WiFi 8 STA.

In other aspects, for example, devices 102, 140 and/or 160 may be configured to perform one or more operations, and/or functionalities of an Ultra High Reliability (UHR) STA.

In other aspects, for example, devices 102, 140, and/or 160 may be configured to perform one or more operations, and/or functionalities of any other additional or alternative type of STA.

In other aspects, device 102, device 140, and/or device 160 may include, operate as, perform the role of, and/or perform one or more functionalities of, any other wireless device and/or station, e.g., a WLAN STA, a WiFi STA, and the like.

In some demonstrative aspects, device 102, device 140, and/or device 160 may be configured operate as, perform the role of, and/or perform one or more functionalities of, an Access Point (AP), e.g., a High Throughput (HT) AP STA, a High Efficiency (HE) AP STA, an EHT AP STA and/or a UHR AP STA.

In some demonstrative aspects, device 102, device 140, and/or device 160 may be configured to operate as, perform the role of, and/or perform one or more functionalities of, a non-AP STA, e.g., an HT non-AP STA, an HE non-AP STA, an EHT non-AP STA and/or a UHR non-AP STA.

In other aspects, device 102, device 140, and/or device 160 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains one station (STA) and provides access to the distribution services, via the wireless medium (WM) for associated STAs. An AP may include a STA and a distribution system access function (DSAF). The AP may perform any other additional or alternative functionality.

In some demonstrative aspects devices 102, 140, and/or 160 may be configured to communicate in an HT network, an HE network, an EHT network, a UHR network, and/or any other network.

In some demonstrative aspects, devices 102, 140 and/or 160 may be configured to operate in accordance with one or more Specifications, for example, including one or more IEEE 802.11 Specifications, e.g., an IEEE 802.11-2020 Specification, an IEEE 802.11ax Specification, and/or any other specification and/or protocol.

In some demonstrative aspects, device 102 may include, operate as, perform a role of, and/or perform the functionality of, an AP STA.

In some demonstrative aspects, device 140, and/or device 160 may include, operate as, perform a role of, and/or perform the functionality of, one or more non-AP STAs. For example, device 140 may include, operate as, perform a role of, and/or perform the functionality of, at least one non-AP STA, and/or device 160 may include, operate as, perform a role of, and/or perform the functionality of, at least one non-AP STA.

In some demonstrative aspects, device 102, device 140, and/or device 160 may include, operate as, perform a role of, and/or perform the functionality of, a Multi-Link Device (MLD). For example, device 102 may include, operate as, perform a role of, and/or perform the functionality of, at least one MLD, device 140 may include, operate as, perform a role of, and/or perform the functionality of, at least one MLD, and/or device 160 may include, operate as, perform a role of, and/or perform the functionality of, at least one MLD, e.g., as described below.

For example, an MLD may include a device that is a logical entity that is capable of supporting more than one affiliated station (STA) and can operate using one or more affiliated STAs. For example, the MLD may present one Medium Access Control (MAC) data service and a single MAC Service Access Point (SAP) to the Logical Link Control (LLC) sublayer. The MLD may perform any other additional or alternative functionality.

In some demonstrative aspects, for example, an infrastructure framework may include a multi-link AP logical entity, which includes APs, e.g., on one side, and a multi-link non-AP logical entity, which includes non-APs, e.g., on the other side.

In some demonstrative aspects, device 102, device 140, and/or device 160 may be configured to operate as, perform the role of, and/or perform one or more functionalities of, an AP MLD.

In some demonstrative aspects, device 102, device 140, and/or device 160 may be configured to operate as, perform the role of, and/or perform one or more functionalities of, a non-AP MLD.

In other aspects, device 102, device 140, and/or device 160 may operate as, perform the role of, and/or perform one or more functionalities of, any other additional or alternative device and/or station.

For example, an AP MLD may include an MLD, where each STA affiliated with the MLD is an AP. In one example, the AP MLD may include a multi-link logical entity, where each STA within the multi-link logical entity is an EHT AP. The AP MLD may perform any other additional or alternative functionality.

For example, a non-AP MLD may include an MLD, where each STA affiliated with the MLD is a non-AP STA. In one example, the non-AP MLD may include a multi-link logical entity, where each STA within the multi-link logical entity is a non-AP EHT STA. The non-AP MLD may perform any other additional or alternative functionality.

In some demonstrative aspects, device 102, device 140, and/or device 160 may be configured to communicate according to a resource allocation mechanism, which may assign a Resource Unit (RU) or a multiple Resource Unit (MRU) to a user (also referred to as “user STA”), e.g., as described below.

In some demonstrative aspects, device 102, device 140, and/or device 160 may be configured to communicate according to a resource allocation mechanism, which may support assignment of a RU/MRU to a user utilizing the same, e.g., equal, modulation and coding scheme (MCS), e.g., as described below.

In some demonstrative aspects, device 102, device 140, and/or device 160 may be configured to communicate according to a resource allocation mechanism, which may support assignment of a RU/MRU to a user utilizing a plurality of different, e.g., unequal, MCSs, e.g., as described below.

In some demonstrative aspects, for example, in some implementations, scenarios, use cases, and/or deployments, there may be one or more technical issues in implementations, which assign an RU or an MRU to a user utilizing the same MCS, e.g., across the entire RU/MRU assigned to the user.

For example, utilizing the same MCS for the entire assigned RU/MRU may result in low throughput, for example, when the RU assigned to the user is across a primary channel and secondary channels.

For example, utilizing the same MCS for the entire assigned RU/MRU may result in low throughput, for example, as a primary channel and a secondary channel may adopt different clear channel assessment (CCA) methods, signal detect CCA and/or energy detect CCA, which may have different sensitivities with respect to the different channels, spatial streams, and/or frequency sub-bands. For example, on a primary channel and a 20 MHz secondary channel, the sensitivity thresholds may be −82 decibel-milliwatts (dBm) (signal detect CCA) and/or −62 dBm (energy detect CCA), respectively. For example, adopting different CCA methods for primary and secondary channels may result in significant signal-to-noise ratio (SNR) imbalance between the primary and secondary channels.

In some demonstrative aspects, device 102, device 140, and/or device 160 may be configured to implement an MCS allocation scheme (also referred to as an “unequal MCS allocation scheme”), which may be configured to assign a plurality of MCSs, e.g., including two or more different MCSs, to a plurality of different segments of an RU/MRU, for example, a plurality of frequency sub-blocks (also referred to as “frequency sub-bands”), e.g., as described below.

In some demonstrative aspects, the unequal MCS allocation scheme may be configured to provide a technical solution address SNR imbalance, for example, to support assignment of different MCSs to different segments of an RU/MRU, for example, when these segments have considerable variations on SNR, for example, in order to fit to their SNR conditions and/or to achieve high throughput, e.g., as described below.

In some demonstrative aspects, the unequal MCS allocation scheme may be configured to provide a technical solution to support allocation of unequal MCS over spatial streams, e.g., as described below.

For example, the unequal MCS over spatial streams may be configured to provide a technical solution to support Multiple-Input-Multiple-Output (MIMO), for example, where MIMO gains are different on different spatial streams, thereby causing various SNR conditions.

In some demonstrative aspects, the unequal MCS allocation scheme may be configured to provide a technical solution to support applying unequal MCSs in different spatial streams and/or on different frequency sub-blocks, for example, to support improved, e.g., significantly improved, throughput.

In some demonstrative aspects, the unequal MCS allocation scheme may be configured to provide a technical solution to support assignment, e.g., adaptive assignment, of varying MCSs to different frequency sub-bands and/or spatial streams, for example, according to varying SNR conditions.

In some demonstrative aspects, device 102, device 140, and/or device 160 may be configured to communicate according to an Unequal MCS (UEM or UMCS) scheme, e.g., as described below.

In some demonstrative aspects, device 102, device 140, and/or device 160 may be configured to communicate a PPDU according to a UEM assignment, e.g., as described below.

In some demonstrative aspects, the UEM assignment may include an assignment of a plurality of MCSs to a plurality of frequency sub-blocks for one or more spatial streams, e.g., as described below.

In some demonstrative aspects, device 102, device 140, and/or device 160 may be configured to implement a signaling mechanism, which may be configured to support signaling of UEM assignment information to indicate, for example, a UEM assignment over a plurality of frequency sub-channels and/or spatial streams, e.g., as described below.

In some demonstrative aspects, the signaling mechanism may be configured to communicate the UEM assignment information, for example, in compliance with a user field format, e.g., in accordance with an IEEE 802.11be Specification, e.g., as described below.

For example, an EHT SIGNAL (SIG) (EHT-SIG) field format, e.g., in accordance with an IEEE 802.11be Specification, may only support assigning a single MCS to each user. For example, the EHT-SIG field format, e.g., in accordance with the IEEE 802.11be Specification, may only be able to support information of one MCS for each user.

In some demonstrative aspects, the EHT-SIG field format may be redesigned, for example, to provide a technical solution to support, e.g., enable, unequal MCS, as described below.

In some demonstrative aspects, the EHT-SIG field format may be redesigned, for example, to provide a technical solution to support using an EHT-SIG field to deliver a plurality of MCSs for a user, e.g., for each user, e.g., as described below.

In some demonstrative aspects, the EHT-SIG field format may be redesigned to support signaling of more than one MCS for a user, for example, while maintaining compliance with the design of the EHT-SIG field format, e.g., in accordance with the IEEE 802.11be Specification.

In some demonstrative aspects, the EHT-SIG field format may be redesigned to support signaling of more than one MCS for a user, for example, while avoiding addition of additional fields and/or subfields into the EHT-SIG field format, e.g., as described below. For example, addition of fields and/or subfields into the EHT-SIG field format may result in increased complexity and/or low compatibility.

In some demonstrative aspects, for example, in some implementations, scenarios, use cases, and/or deployments, it may be enough to support an assignment of unequal MCSs over a relatively small number of spatial streams.

For example, in many use cases and/or implementations, it may be sufficient to use two spatial streams with two unequal MCSs, which may be assigned to a user, for example, when unequal MCS is applied.

In some demonstrative aspects, device 102, device 140, and/or device 160 may be configured to implement a UEM signaling mechanism, which may be configured to provide a technical solution to support signaling UEM assignment information, for example, while using a SIG field format, which may be, for example, in compliance with an EHT-SIG field format, e.g., as described below.

In some demonstrative aspects, the UEM signaling mechanism may be configured to provide a technical solution to support signaling UEM assignment information, for example, while using a SIG field format, which may be configured to support signaling a UEM assignment of a plurality of unequal MCSs for a user, e.g., as described below.

In some demonstrative aspects, the SIG field format may be configured to support signaling a UEM assignment of a two unequal MCSs for a user, for example, per each user, e.g., as described below.

In some demonstrative aspects, the UEM signaling mechanism may configured to provide a technical solution to support signaling UEM assignment information, for example, while using a SIG field format, which may be compatible with an EHT-SIG field format, e.g., in compliance with the IEEE 802.11be Specification, e.g., as described below.

In some demonstrative aspects, the UEM signaling mechanism may be configured to utilize the SIG field format, which may be compatible with the EHT-SIG field format, for example, to provide a technical solution to support signaling of UEM assignment information, for example, with reduced complexity and/or high compatibility, e.g., as described below.

In some demonstrative aspects, device 102, device 140, and/or device 160 may be configured to implement a UEM signaling mechanism, which may be configured to support an unequal MCS with two MCSs for each user, for example, while using a SIG field format (also referred to as “UEM SIG field format”), which may be configured in compliance with the EHT-SIG format, e.g., in accordance with the IEEE 802.11be Specification.

In some demonstrative aspects, the UEM SIG field format may be configured to support signaling of a plurality of MCSs, e.g., two MCSs, per user, e.g., as described below.

In some demonstrative aspects, the UEM SIG field format may be configured to provide a technical solution to support signaling of the plurality of MCS per user, for example, while maintaining compatibility with a structure of an EHT-SIG field, which may be substantially unchanged, e.g., as described below.

In some demonstrative aspects, the UEM SIG field format may be configured to provide a technical solution to support signaling of the plurality of MCS per user, for example, even without adding any additional fields and/or subfields to the EHT-SIG field format, e.g., as described below.

In some demonstrative aspects, controller 124 may be configured to control, trigger, cause, and/or instruct an AP implemented by device 102 to set a user specific field in a Signal (SIG) field, e.g., as described below.

In some demonstrative aspects, the user specific field may be configured for a user of a plurality of users in an MU-MIMO allocation, e.g., as described below.

In some demonstrative aspects, the user specific field for the user may include a UEM information subfield, which may be configured to indicate an assignment of a plurality of MCSs for the user, e.g., as described below.

In some demonstrative aspects, the user specific field for the user may include a spatial configuration subfield, which may be configured to indicate a number of spatial streams for the user, e.g., as described below.

In some demonstrative aspects, the spatial configuration subfield may be configured to indicate a total number of spatial streams in the MU-MIMO allocation, e.g., as described below.

In other aspects, the spatial configuration subfield may include any other additional or alternative information.

In some demonstrative aspects, controller 124 may be configured to control, trigger, cause, and/or instruct the AP implemented by device 102 to transmit a PPDU, which includes the SIG field, e.g., as described below.

In some demonstrative aspects, the SIG field may include an EHT-SIG field, e.g., as described below.

In other aspects, the SIG field may include any other type of SIG field.

In some demonstrative aspects, the PPDU may include an EHT PPDU, e.g., as described below.

In some demonstrative aspects, the PPDU may include a UHR PPDU, e.g., as described below.

In other aspects, the PPDU may include any other type of PPDU.

In some demonstrative aspects, as size of the user specific field for the user may be configured in accordance with a size of an EHT-SIG field, e.g., as described below.

In some demonstrative aspects, the user specific field for the user may have a bit size of 22 bits, e.g., as described below.

In other aspects, the user specific field for the user may have any other bit size.

In some demonstrative aspects, the user specific field for the user may include the UEM information subfield and the spatial configuration subfield, which may be configured to have a total size of 11 bits, e.g., as described below.

In some demonstrative aspects, the user specific field for the user may include the UEM information subfield, which may have a size of at least 6 bits, e.g., as described below.

In some demonstrative aspects, the UEM information subfield may have a size of 6 bits, e.g., as described below.

In some demonstrative aspects, the UEM information subfield may have a size of 7 bits, e.g., as described below.

In other aspects, the UEM information subfield may have any other size.

In some demonstrative aspects, the user specific field for the user may include the spatial configuration subfield, which may have a size of no more than 4 bits, e.g., as described below.

In some demonstrative aspects, the spatial configuration subfield may have a size of 4 bits, e.g., as described below.

In some demonstrative aspects, the spatial configuration subfield may have a size of 3 bits, e.g., as described below.

In other aspects, the spatial configuration subfield may have any other size.

In some demonstrative aspects, controller 124 may be configured to control, trigger, cause, and/or instruct the AP implemented by device 102 to set a value of the spatial configuration subfield, for example, according to a predefined spatial configuration subfield encoding, e.g., as described below.

In some demonstrative aspects, the predefined spatial configuration subfield encoding may be configured to support an indication of up to two spatial streams per user and up to eight spatial streams in total, e.g., as described below.

In some demonstrative aspects, the predefined spatial configuration subfield encoding may be configured to support an indication of up to four spatial streams per user and up to eight spatial streams in total, e.g., as described below.

In other aspects, the predefined spatial configuration subfield encoding may be configured to support an indication of any other number of spatial streams per user and/or any other total number of spatial streams.

In some demonstrative aspects, the user specific field for the user may be configured, for example, according to a user specific field format, e.g., as described below.

In some demonstrative aspects, the user specific field format may be configured in compliance with an EHT-SIG field format, e.g., as described below.

In some demonstrative aspects, the user specific field format may include a STA identifier (ID) (STA-ID) field, which may be configured to identify the user, e.g., as described below.

In some demonstrative aspects, the user specific field format may include the UEM information subfield, for example, after the STA-ID field, e.g., as described below.

In some demonstrative aspects, the user specific field format may include the spatial configuration subfield, for example, after the UEM information subfield, e.g., as described below.

In some demonstrative aspects, the user specific field format may include a coding subfield between the UEM information subfield and the spatial configuration subfield, e.g., as described below.

In some demonstrative aspects, the user specific field format may be configured to exclude the coding subfield, e.g., as described below.

In some demonstrative aspects, the user specific field format may be configured such that the spatial configuration subfield is directly after the UEM information subfield, e.g., as described below.

In other aspects, the user specific field format may include any other additional or alternative subfields.

In some demonstrative aspects, the UEM information subfield in the user field for the user may include a first MCS value to indicate a first MCS of the plurality of MCSs for the user, e.g., as described below.

In some demonstrative aspects, the UEM information subfield in the user field for the user may include a second MCS value to indicate a second MCS of the plurality of MCSs for the user, e.g., as described below.

In some demonstrative aspects, the second MCS value may be configured to indicate the second MCS, for example, based on the first MCS value, e.g., as described below.

In some demonstrative aspects, the second MCS value may be configured to indicate the second MCS, for example, based on a predefined mapping of a plurality of predefined second MCSs to a plurality of combinations between a plurality of predefined first MCS values and a plurality of predefined second MCS values, e.g., as described below.

In some demonstrative aspects, the second MCS value may be configured to indicate a difference between a modulation order of the first MCS and a modulation order of the second MCS, e.g., as described below.

In some demonstrative aspects, the second MCS value may be configured to indicate a modulation order of the second MCS, e.g., as described below.

In other aspects, the second MCS value may be configured to indicate any other alternative or additional information regarding the second MCS.

In some demonstrative aspects, the first MCS may have a higher modulation order than the second MCS, e.g., as described below.

In some demonstrative aspects, the first MCS and the second MCS may have a same coding rate, e.g., as described below.

In other aspects, the first MCs and/or the second MCS may include any other MCSs having any coding rates and/or modulation orders.

In some demonstrative aspects, the first MCS value may include an MCS index of the first MCS, e.g., as described below.

In some demonstrative aspects, the first MCS value may have a size of 4 bits, e.g., as described below.

In other aspects, the first MCS value may have any other bit-size.

In some demonstrative aspects, the second MCS value may have a size of up to 4 bits, e.g., as described below.

In some demonstrative aspects, the second MCS value may have a size of 3 bits, e.g., as described below.

In other aspects, the second MCS value may have any other bit-size.

In some demonstrative aspects, a difference between a modulation order of the first MCS and a modulation order of the second MCS may be more than 3, e.g., as described below.

In other aspects, a difference between a modulation order of the first MCS and a modulation order of the second MCS may be equal to or less than 3.

In some demonstrative aspects, the UEM information subfield in the user field for the user may include a UEM value, which may be configured to indicate both the first MCS and the second MCS for the user, e.g., as described below.

In some demonstrative aspects, the UEM value may be configured to indicate both the first MCS and the second MCS, for example, based on a predefined mapping of a plurality of predefined UEM values to a plurality of predefined combinations of first and second MCSs, e.g., as described below.

In some demonstrative aspects, the UEM information subfield in the user field for the user may include a coding-rate value, which may be configured to indicate a same coding rate for both the first MCS and the second MCS for the user, e.g., as described below.

In some demonstrative aspects, the UEM information subfield may include a modulation value, which may be configured to indicate a modulation of the first MCS and a modulation of the second MCS, e.g., as described below.

In some demonstrative aspects, the modulation value may be configured to indicate both the modulation of the first MCS and the modulation of the second MCS, for example, based on a predefined mapping of a plurality of predefined modulation values to a plurality of predefined combinations of first and second modulations, e.g., as described below.

In other aspects, the UEM information subfield in the user field for the user may include any other additional and/or alternative information regarding the first MCS and the second MCS for the user.

In some demonstrative aspects, controller 124 may be configured to control, trigger, cause, and/or instruct the AP implemented by device 102 to set in the SIG field a non-UEM user specific field for a non-UEM user of the plurality of users.

In some demonstrative aspects, the non-UEM user specific field may include an MCS information subfield configured to indicate an assignment of a single MCS to the non-UEM user.

In some demonstrative aspects, controller 154 may be configured to control, trigger, cause, and/or instruct a user STA implemented by device 140 to identify a user specific field for the user STA in a SIG field of a PPDU, which may be received by the user STA from an AP, e.g., as described below.

In some demonstrative aspects, the SIG field of the PPDU received by the user STA implemented by device 140 may be configured for an MU-MIMO allocation, e.g., as described below.

In some demonstrative aspects, the PPDU received by the user STA implemented by device 140 may include the PPDU transmitted by the AP implemented by device 102, e.g., as described above.

In some demonstrative aspects, controller 154 may be configured to control, trigger, cause, and/or instruct the user STA implemented by device 140 to process a UEM information subfield in the user specific field for the user STA, for example, to identify an assignment of a plurality of MCSs for the user STA, e.g., as described below.

In some demonstrative aspects, controller 154 may be configured to control, trigger, cause, and/or instruct the user STA implemented by device 140 to process a spatial configuration subfield in the user specific field for the user STA, for example, to identify a number of spatial streams for the user STA, e.g., as described below.

In some demonstrative aspects, controller 154 may be configured to control, trigger, cause, and/or instruct the user STA implemented by device 140 to process the spatial configuration subfield in the user specific field for the user STA, for example, to identify a total number of spatial streams in the MU-MIMO allocation, e.g., as described below.

In some demonstrative aspects, controller 154 may be configured to control, trigger, cause, and/or instruct the user STA implemented by device 140 to process a transmission for the user STA, for example, based on the assignment of the plurality of MCSs for the user STA, e.g., as described below.

In some demonstrative aspects, controller 154 may be configured to control, trigger, cause, and/or instruct the user STA implemented by device 140 to process the transmission for the user STA, for example, based on the number of spatial streams for the user STA, e.g., as described below.

In some demonstrative aspects, controller 154 may be configured to control, trigger, cause, and/or instruct the user STA implemented by device 140 to determine the number of spatial streams for the user STA, for example, by processing a value of the spatial configuration subfield, for example, according to a predefined spatial configuration subfield encoding, e.g., as described below.

In some demonstrative aspects, controller 154 may be configured to control, trigger, cause, and/or instruct the user STA implemented by device 140 to determine the number of spatial streams for the user STA, for example, by processing the value of the spatial configuration subfield according to a predefined spatial configuration subfield encoding, which may be configured to support an indication of up to two spatial streams per user and up to eight spatial streams in total, e.g., as described below.

In some demonstrative aspects, controller 154 may be configured to control, trigger, cause, and/or instruct the user STA implemented by device 140 to determine the number of spatial streams for the user STA, for example, by processing the value of the spatial configuration subfield according to a predefined spatial configuration subfield encoding, which may be configured to support an indication of up to four spatial streams per user and up to eight spatial streams in total, e.g., as described below.

In other aspects, controller 154 may be configured to control, trigger, cause, and/or instruct the user STA implemented by device 140 to determine the number of spatial streams for the user STA, for example, by processing the value of the spatial configuration subfield according to any other predefined spatial configuration subfield encoding, e.g., to support an indication of any other number of spatial streams and/or any other total number of spatial streams.

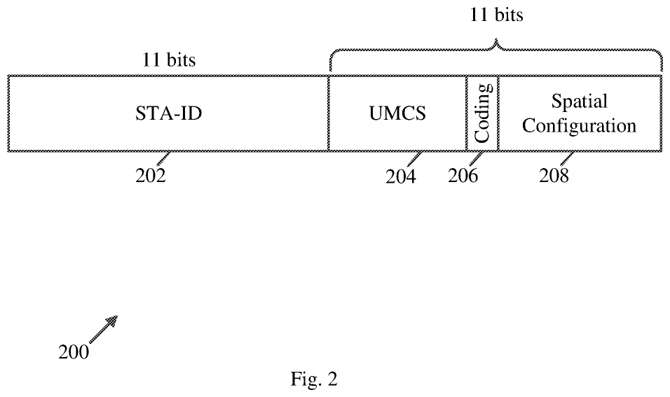

Reference is made to FIG. 2, which schematically illustrates a format of a user specific field 200, in accordance with some demonstrative aspects.

For example, user specific field 200 may include a user field format, which may be included in a SIG field of a PPDU.

For example, user specific field 200 may include a user field format, which may be configured to carry information for a user of a plurality of users in an MU-MIMO allocation.

For example, as shown in FIG. 2, user specific field 200 may have a bit size of 22 bits.

For example, device 102 (FIG. 1) may be configured to generate, process, and/or transmit a PPDU including a SIG field, which may include user specific field 200, for example, to provide user-specific information corresponding to a user of a plurality of users in a MU-MIMO allocation.

For example, device 140 (FIG. 1) and/or device 160 (FIG. 1) may be configured to receive and/or process a PPDU including a SIG field, which may include user specific field 200, for example, to identify user-specific information corresponding to a user of the plurality of users in the MU-MIMO allocation.

In some demonstrative aspects, the SIG field may include an EHT-SIG field.

In some demonstrative aspects, the PPDU may include an EHT PPDU.

In some demonstrative aspects, the PPDU may include a UHR PPDU.

In other aspects, user specific field 200 may be included in any other type of SIG field, and/or as part of any other type of PPDU.

In some demonstrative aspects, as shown in FIG. 2, user specific field 200 may include a STA-ID field 202 to identify the user to which the user specific field 200 corresponds.

In some demonstrative aspects, as shown in FIG. 2, user specific field 200 may include a UMCS subfield 204, for example, after the STA-ID field 202.

In some demonstrative aspects, UMCS subfield 204 may be configured to indicate an assignment of a plurality of MCSs for the user identified by the STA-ID field 202.

In some demonstrative aspects, as shown in FIG. 2, user specific field 200 may include a spatial configuration subfield 208, for example, after the UMCS subfield 204.

In some demonstrative aspects, spatial configuration subfield 208 may be configured to indicate a number of spatial streams for the user and/or a total number of spatial streams in the MU-MIMO allocation.

In some demonstrative aspects, as shown in FIG. 2, user specific field 200 may include a coding subfield 206, for example, between the UMCS subfield 204 and the spatial configuration subfield 208.

In some demonstrative aspects, UMCS subfield 204 may include a first MCS value to indicate a first MCS of the plurality of MCSs for the user, and a second MCS value to indicate a second MCS of the plurality of MCSs for the user, e.g., as described below.

In some demonstrative aspects, UMCS subfield 204 may include a UEM value configured to indicate both the first MCS and the second MCS for the user, e.g., as described below.

In some demonstrative aspects, UMCS subfield 204 may include a coding-rate value to indicate a same coding rate for both the first MCS and the second MCS for the user, e.g., as described below.

In some demonstrative aspects, UMCS subfield 204 may include a modulation value configured to indicate a modulation of the first MCS and a modulation of the second MCS for the user, e.g., as described below.

In other aspects, UMCS subfield 204 may include any other additional or alternative information to indicate an assignment of the plurality of MCSs for the user.

In some demonstrative aspects, UMCS subfield 204 may have a size of at least 6 bits, e.g., as described below.

In some demonstrative aspects, UMCS subfield 204 may have a size of 6 bits, e.g., as described below.

In some demonstrative aspects, UMCS subfield 204 may have a size of 7 bits, e.g., as described below.

In other aspects, UMCS subfield 204 may have any other bit size.

In some demonstrative aspects, spatial configuration subfield 208 may have a size of no more than 4 bits, e.g., as described below.

In some demonstrative aspects, spatial configuration subfield 208 may have a size of 4 bits, e.g., as described below.

In some demonstrative aspects, spatial configuration subfield 208 may have a size of 3 bits, e.g., as described below.

In other aspects, spatial configuration subfield 208 may have any other bit size.

In some demonstrative aspects, a value of the spatial configuration subfield 208 may be set, for example, according to a predefined spatial configuration subfield encoding, which may be configured, for example, to support an indication of up to two spatial streams per user and up to eight spatial streams in total, e.g., as described below.

In some demonstrative aspects, a value of the spatial configuration subfield 208 may be set, for example, according to a predefined spatial configuration subfield encoding, which may be configured, for example, to support an indication of up to four spatial streams per user and up to eight spatial streams in total, e.g., as described below.

In some demonstrative aspects, the user specific field 200 may be configured to be compatible with an EHT-SIG user field format, e.g., in accordance with the IEEE 802.11be Specification.

For example, the user specific field 200 may include 11 bits that may be used for UMCS subfield 204, spatial configuration subfield 208, and/or coding subfield 206.

In some demonstrative aspects, the user specific field 200 may be configured to use 11 bits for UMCS subfield 204, spatial configuration subfield 208, and/or coding subfield 206, for example, to provide a technical solution of a user specific field format utilizing 11 bits, e.g., in compliance with the EHT-SIG field format.

For example, the EHT-SIG field format, e.g., in accordance with the IEEE 802.11be Specification, may include a 4-bit MCS subfield, a 1-bit coding subfield, and a 6-bit spatial configuration subfield. For example, the 4-bit MCS subfield of the EHT-SIG field may be configured to carry MCS information, which only delivers information of one MCS.

In some demonstrative aspects, the user specific field 200 may be configured to provide a technical solution to support carrying information of two unequal MCSs for a user, e.g., while maintaining compliance with the EHT-SIG format.

For example, a spatial configuration subfield according to the EHT-SIG format may be designed to include 6 bits to support up to 4 spatial streams for each user, and up to 8 spatial streams in total.

In some demonstrative aspects, spatial configuration subfield 208 may be configured to utilize a reduced number of bits, for example, compared to the spatial configuration subfield of the EHT-SIG format, e.g., 4 bits instead of 6 bits.

In some demonstrative aspects, for example, in many use cases and/or implementations, a number of users, which is indicated by RU-Allocation subfields, and/or a number of spatial stream allocation options may be less than 14, e.g., for any given number of users. Accordingly, a 4-bit spatial configuration subfield may be sufficient to provide information, for example, for all possible spatial stream allocations.

In some demonstrative aspects, 2 bits of the 6-bit spatial configuration subfield may be repurposed for an MCS indication, for example, as part of UMCS field 204, e.g., as described below.

In some demonstrative aspects, spatial configuration subfield 208 may be configured according to a predefined spatial configuration subfield encoding scheme, e.g., as described below.

For example, device 102 (FIG. 1), device 140 (FIG. 1), and/or device 160 (FIG. 1) may be configured to implement the predefined spatial configuration subfield encoding scheme, for example, to encode, process, and/or decode, spatial configuration information in spatial configuration subfield 208.

In some demonstrative aspects, the predefined spatial configuration subfield encoding scheme may be configured to provide a technical solution to support an implementation of spatial configuration subfield 208 to provide information of one or more, e.g., all, possible spatial stream allocations, e.g., as described below.

In some demonstrative aspects, the predefined spatial configuration subfield encoding scheme may be configured to support implementation of the user specific field 200, for example, to support signaling of a UEM assignment for up to two MCSs and two spatial streams per user, e.g., as described below.

In some demonstrative aspects, the predefined spatial configuration subfield encoding scheme may include an encoding scheme, which may be configured support an indication of up to two spatial streams per user and up to eight spatial streams in total, e.g., as follows:

TABLE 1

| | | Nₛₛ | Nₛₛ | Nₛₛ | Nₛₛ | Nₛₛ | Nₛₛ | Nₛₛ | Nₛₛ | Total | Total |
|---|---|---|---|---|---|---|---|---|---|---|---|
| Nᵤₛₑᵣ | B5 . . . B0 | [1] | [2] | [3] | [4] | [5] | [6] | [7] | [8] | Nₛₛ | entries |
| 2 | 000- | 1-2 | 1 | | | | | | | 2-3 | 3 |
| | 001 | | | | | | | | | | |
| | 010 | 2 | 2 | | | | | | | 4 | |
| 3 | 000- | 1-2 | 1 | 1 | | | | | | 3-4 | 4 |
| | 001 | | | | | | | | | | |
| | 010 | 2 | 2 | 1 | | | | | | 5 | |
| | 011 | 2 | 2 | 2 | | | | | | 6 | |
| 4 | 000- | 1-2 | 1 | 1 | 1 | | | | | 4-5 | 5 |
| | 001 | | | | | | | | | | |
| | 010 | 2 | 2 | 1 | 1 | | | | | 6 | |
| | 011 | 2 | 2 | 2 | 1 | | | | | 7 | |
| | 100 | 2 | 2 | 2 | 2 | | | | | 8 | |
| 5 | 000- | 1-2 | 1 | 1 | 1 | 1 | | | | 5-6 | 4 |
| | 001 | | | | | | | | | | |
| | 010 | 2 | 2 | 1 | 1 | 1 | | | | 7 | |
| | 011 | 2 | 2 | 2 | 1 | 1 | | | | 8 | |
| 6 | 000- | 1-2 | 1 | 1 | 1 | 1 | 1 | | | 6-7 | 3 |
| | 001 | | | | | | | | | | |
| | 010 | 2 | 2 | 1 | 1 | 1 | 1 | | | 8 | |
| 7 | 000- | 1-2 | 1 | 1 | 1 | 1 | 1 | 1 | | 7-8 | 2 |
| | 001 | | | | | | | | | | |
| 8 | 000 | 1 | 1 | 1 | 1 | 1 | 1 | 1 | 1 | 8 | 1 |

For example, according to Table 1, a reduced number of bits, e.g., 3 bits rather than 6 bits, may be sufficient to support encoding of the spatial stream configuration information for up to two spatial streams per user and eight spatial streams in total.

In some demonstrative aspects, configuring the spatial configuration subfield using the reduced number of bits, e.g., 3 bits, may provide a technical solution to support additional bits for UMCS subfield 204, e.g., as described below.

In some demonstrative aspects, UMCS subfield 204 may be configured to include 4 bits, e.g., corresponding to the 4 bits of the MCS subfield of the EHT-SIG format, and 3 bits, which may be redistributed from the spatial configuration subfield of the EHT-SIG format.

In some demonstrative aspects, UMCS subfield 204 may include 7 bits in total, which may be used to deliver information of unequal MCS.

In some demonstrative aspects, a SIG field, which is a physical layer header, may be designed to support unequal MCS signaling, for example, using the 7 bits of UMCS subfield 204, e.g., as described below.

In some demonstrative aspects, UMCS subfield 204 may be configured to provide a technical solution to utilize 7 bits, for example, to represent 2 MCSs of a user, e.g., as described below.

In some demonstrative aspects, a user, e.g., each user, of a MU-MIMO allocation, may be provided with a user specific field, e.g., according to the user specific field format 200, for example, in a SIG field.

In some demonstrative aspects, a user, e.g., each user, of a MU-MIMO allocation, may have up to 2 unequal MCSs.

In some demonstrative aspects, as shown in FIG. 2, the user specific field format 200 may be configured to include a plurality of types of subfields, e.g., including a 11-bit STA-ID subfield 202, a UMCS subfield 204, e.g., including 7 bits, a 1-bit coding subfield 206, and/or a 3-bit spatial configuration subfield 208, e.g., as described below.

In some demonstrative aspects, the 3-bit spatial configuration subfield 208 may be configured to have a reduced number of bits, for example, 3 bits instead of 6 bits, e.g., in accordance with Table 1.

For example, 3 bits, which are saved in the spatial configuration subfield 208, may be relocated to the UMCS subfield 204, for example, such that the UMCS subfield 204 may include a total of 7 bits, e.g., as described above.

In some demonstrative aspects, UMCS subfield 204 may be configured according to one or more designs, which may be configured to utilize the 7 bits to support signaling of up to two MCSs per user, e.g., as described below.

In some demonstrative aspects, UMCS subfield 204 may be configured according to a UMCS subfield design, which uses the first 4 bits of UMCS subfield 204 to indicate a first MCS, e.g., as described below.

In some demonstrative aspects, UMCS subfield 204 may be configured according to a UMCS subfield design, which uses the remaining 3 bits, e.g., the 3 bits relocated from the spatial configuration subfield, to indicate a second MCS, e.g., as described below.

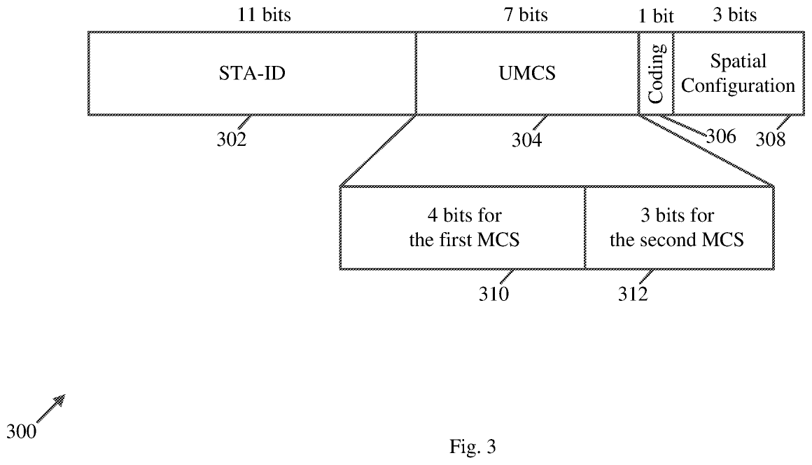

Reference is made to FIG. 3, which schematically illustrates a format of a user specific field 300, in accordance with some demonstrative aspects.

For example, user specific field 300 may include a user field format, which may be included in a SIG field of a PPDU.

For example, user specific field 300 may include a user field format, which may be configured to carry information for a user of a plurality of users in an MU-MIMO allocation.

For example, as shown in FIG. 3, user specific field 300 may have a bit size of 22 bits.

In some demonstrative aspects, one or more subfields of user specific field 200 (FIG. 2) may be configured according to one or more subfields of user specific field 300.

For example, device 102 (FIG. 1) may be configured to generate, process, and/or transmit a PPDU including a SIG field, which may include user specific field 300, for example, to provide user-specific information corresponding to a user of a plurality of users in a MU-MIMO allocation.

For example, device 140 (FIG. 1) and/or device 160 (FIG. 1) may be configured to receive and/or process a PPDU including a SIG field, which may include user specific field 300, for example, to identify user-specific information corresponding to a user of the plurality of users in the MU-MIMO allocation.

In some demonstrative aspects, as shown in FIG. 3, user specific field 300 may include a STA-ID field 302 to identify the user to which the user specific field 300 corresponds.

In some demonstrative aspects, as shown in FIG. 3, user specific field 300 may include a UMCS subfield 304, for example, after the STA-ID field 302.

In some demonstrative aspects, UMCS subfield 304 may be configured to indicate an assignment of a plurality of MCSs for the user identified by the STA-ID field 302.

In some demonstrative aspects, as shown in FIG. 3, user specific field 300 may include a spatial configuration subfield 308, for example, after the UMCS subfield 304.

In some demonstrative aspects, spatial configuration subfield 308 may be configured to indicate a number of spatial streams for the user and a total number of spatial streams in the MU-MIMO allocation.

In some demonstrative aspects, as shown in FIG. 3, user specific field 300 may include a coding subfield 306, for example, between the UMCS subfield 304 and the spatial configuration subfield 308.

In some demonstrative aspects, as shown in FIG. 3, spatial configuration subfield 308 may have a size of 3 bits.

In some demonstrative aspects, spatial configuration subfield 308 may be encoded, for example, according to Table 1, e.g., as described above.

In some demonstrative aspects, UMCS subfield 304 may include a first MCS value 310 to indicate a first MCS of the plurality of MCSs for the user, and a second MCS value 312 to indicate a second MCS for the user, e.g., as described below.

In some demonstrative aspects, as shown in FIG. 3, UMCS subfield 304 may have a size of 7 bits.

In some demonstrative aspects, as shown in FIG. 3, UMCS subfield 304 may include 4 bits, e.g., including 4 first bits of UMCS subfield 304, which may be configured to represent the first MCS value 310, e.g., to convey information of the first MCS or the user.

In some demonstrative aspects, as shown in FIG. 3, UMCS subfield 304 may include 3 bits, e.g., including the 3 remaining bits of UMCS subfield 304, which may be configured to represent the second MCS value 312.

In some demonstrative aspects, the second MCS value 312, e.g., as represented the last three bits of UMCS field 304, may be configured to indicate a difference between a modulation order of the first MCS and a modulation order of the second MCS, e.g., as described below.

In some demonstrative aspects, the first MCS value 310 may be configured to represent an index of the first MCS for the user, e.g., the MCS with the largest modulation order. For example, the index of the first MCS may be configured to indicate both modulation and coding rate information for the first MCS.

In some demonstrative aspects, unequal MCSs of a user may share the same coding rate. For example, the unequal MCSs for the user may defer by their modulations, e.g., in accordance with an IEEE 802.11be Specification.

In some demonstrative aspects, the second MCS value 312, e.g., as represented the last three bits of UMCS field 304, may be utilized to indicate a modulation order deduction of the second MCS, for example, compared to the first MCS, e.g., rather than the MCS index of the second MCS.

For example, an MCS index may be configured to indicate a modulation order from a plurality of predefined modulation orders, e.g., including 7 modulation orders, for example, including Binary Phase-Shift Keying (BPSK), Quadrature Phase Shift Keying (QPSK), 16 Quadrature Amplitude Modulation (QAM) (16-QAM), 64-QAM, 256-QAM, 1024-QAM, and/or 4096-QAM.

For example, in case of unequal MCS, a largest modulation order deduction may occur when the first MCS includes the 4096-QAM modulation, and the second MCS includes the BPSK modulation. According to this example, the largest modulation order deduction may include a deduction of 6 modulation orders, e.g., from 4096-QAM to BPSK. Accordingly, 3 bits may be sufficient to present all possibilities of the modulation order deduction between the first MCS and the second MCS.

In some demonstrative aspects, UMCS subfield 304 may be configured to indicate the first MCS and the second MCS, for example, according to their modulation orders.

In some demonstrative aspects, the first MCS value 310, e.g., as represented the first four bits of UMCS field 304, may be configured based on the first MCS, which may have the higher modulation order, and the second MCS value 312, e.g., as represented the last three bits of UMCS field 304, may be configured based on the second MCS, which may have the lower modulation order.

In some demonstrative aspects, spatial configuration subfield 308 may be configured to indicate the first and second spatial streams for the user, for example, in an order which may be based on the modulation orders of the two spatial streams for the user, for example, such that the spatial stream with the highest modulation order may be indicated first, and the second spatial stream with the lowest modulation order may be indicated second. This ordering may ensure, for example, that the first MCS value 310 relates to the spatial stream with the higher modulation order.

In some demonstrative aspects, the three bits of the second MCS value 312 may be configured to indicate the modulation order of the second spatial stream, where, for example, the modulation order doesn't need to be sorted.

In some demonstrative aspects, the first MCS value 310 may be configured to indicate the modulation order of the first spatial stream as well as the coding rate of both spatial streams. For example, the second MCS value 312, e.g., as represented the last three bits of UMCS field 304, may be configured to indicate the modulation order of the second spatial stream.

In some demonstrative aspects, the second MCS value 312, e.g., as represented the last three bits of UMCS field 304, may be configured to represent the modulation order deduction between the first MCS and the second MCS, for example, according to a predefined mapping of a plurality of predefined second MCSs to a plurality of combinations between a plurality of predefined first MCS modulation orders and a plurality of predefined second MCS values, e.g., as follows:

TABLE 2

| | Last 3 Bits of a UMCS Subfield | | | | | | | |
|---|---|---|---|---|---|---|---|---|
| First MCS's | 000 | 001 | 010 | 011 | 100 | 101 | 110 | 111 |

| Modulation | Second MCS's Modulation | | | | | | |
|---|---|---|---|---|---|---|---|
| BPSK | BPSK | | | | | | |
| QPSK | QPSK | BPSK | | | | | |
| 16- | 16- | QPSK | BPSK | | | | |
| QAM | QAM | | | | | | |
| 64- | 64- | 16- | QPSK | BPSK | | | |
| QAM | QAM | QAM | | | | | |
| 256- | 256- | 64- | 16- | QPSK | BPSK | | |
| QAM | QAM | QAM | QAM | | | | |
| 1024- | 1024- | 256- | 64- | 16- | QPSK | BPSK | |
| QAM | QAM | QAM | QAM | QAM | | | |
| 4096- | 4096- | 1024- | 256- | 64- | 16- | QPSK | BPSK |
| QAM | QAM | QAM | QAM | QAM | QAM | | |

For example, as shown in Table 2, the second MCS value 312, e.g., as represented the last three bits of UMCS field 304, may be set to “000”, for example, to indicate a case of equal MCS, e.g., when the first MCS and the second MCS have a same modulation order.

For example, according to Table 2, other 3-bit binary numbers, e.g., except entry ‘000’, may indicate the modulation order deduction between the first MCS and the second MCS.

For example, as shown in line 6 of Table 2, the second MCS value 312, e.g., as represented the last three bits of UMCS field 304, may be set to the value ‘010’, for example, in case the modulation of the second MCS is 2 orders lower than that the modulation of the first MCS, for example, in case a modulation of the first MCS is 1024-QAM and a modulation of the second MCS is 64-QAM.

Referring back to FIG. 2, in some demonstrative aspects, UMCS subfield 204 may be configured according to a UMCS subfield design, which is configured to support indication, e.g., direct indication, of a combination of the first MCS and the second MCS for the user, e.g., as described below.

In some demonstrative aspects, UMCS subfield 204 may include a UEM value, which may be configured to indicate both the first MCS and the second MCS for the user, e.g., as described below.

In some demonstrative aspects, the UEM value may be configured to indicate both the first MCS and the second MCS for the user, for example, based on a predefined mapping of a plurality of predefined UEM values to a plurality of predefined combinations of first and second MCSs, e.g., as described below.

In some demonstrative aspects, the plurality of predefined UEM values may be configured to cover substantially all possible combinations of MCSs for two spatial streams, for example, using a 7-bit value, e.g., represented by the 7 bits of UMCS subfield 204, e.g., as described below.

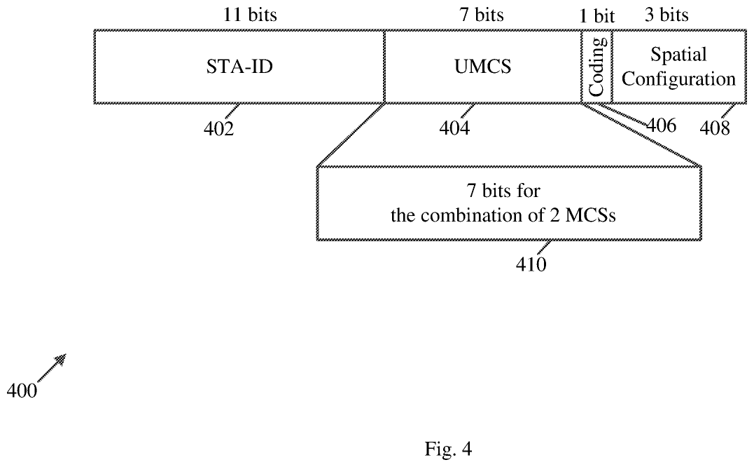

Reference is made to FIG. 4, which schematically illustrates a format of a user specific field 400, in accordance with some demonstrative aspects.

For example, user specific field 400 may include a user field format, which may be included in a SIG field of a PPDU.

For example, user specific field 400 may include a user field format, which may be configured to carry information for a user of a plurality of users in an MU-MIMO allocation.

For example, as shown in FIG. 4, user specific field 400 may have a bit size of 22 bits.

In some demonstrative aspects, one or more subfields of user specific field 200 (FIG. 2) may be configured according to one or more subfields of user specific field 400.

For example, device 102 (FIG. 1) may be configured to generate, process, and/or transmit a PPDU including a SIG field, which may include user specific field 400, for example, to provide user-specific information corresponding to a user of a plurality of users in a MU-MIMO allocation.

For example, device 140 (FIG. 1) and/or device 160 (FIG. 1) may be configured to receive and/or process a PPDU including a SIG field, which may include user specific field 400, for example, to identify user-specific information corresponding to a user of the plurality of users in the MU-MIMO allocation.

In some demonstrative aspects, as shown in FIG. 4, user specific field 400 may include a STA-ID field 402 to identify the user to which the user specific field 400 corresponds.

In some demonstrative aspects, as shown in FIG. 4, user specific field 400 may include a UMCS subfield 404, for example, after the STA-ID field 402.

In some demonstrative aspects, UMCS subfield 404 may be configured to indicate an assignment of a plurality of MCSs for the user identified by the STA-ID field 402.

In some demonstrative aspects, as shown in FIG. 4, user specific field 400 may include a spatial configuration subfield 408, for example, after the UMCS subfield 404.

In some demonstrative aspects, spatial configuration subfield 408 may be configured to indicate a number of spatial streams for the user and a total number of spatial streams in the MU-MIMO allocation.

In some demonstrative aspects, as shown in FIG. 4, spatial configuration subfield 408 may have a size of 3 bits.

In some demonstrative aspects, spatial configuration subfield 408 may be encoded, for example, according to Table 1, e.g., as described above.

In some demonstrative aspects, as shown in FIG. 4, user specific field 400 may include a coding subfield 406, for example, between the UMCS subfield 404 and the spatial configuration subfield 408.

In some demonstrative aspects, as shown in FIG. 4, UMCS subfield 404 may have a size of 7 bits.

In some demonstrative aspects, UMCS subfield 404 may include a UEM value 410, e.g., represented by the 7 bits of UMCS subfield 404, configured to indicate both a first MCS and a second MCS assigned to the user identified by the STA-ID field 402.

In some demonstrative aspects, UEM value 410 may be configured to indicate both the first MCS and the second MCS, for example, based on a predefined mapping of a plurality of predefined UEM values to a plurality of predefined combinations of first and second MCSs.

For example, 7 bits of the UMCS subfield 404 may be configured to indicate an index of a combination with two MCSs.

For example, the two unequal MCSs of the user may share the same coding rate, and may have different modulations. For example, it may be defined that a modulation order of the first MCS may, e.g., may always, be larger than a modulation order of the second MCS, e.g., as described above.

For example, the plurality of predefined combinations of first and second MCSs, e.g., representing all possible modulation combinations, may be defined, e.g., as follows:

TABLE 3

| First | | | | | | | | |
|---|---|---|---|---|---|---|---|---|
| MCS's | | | | | | | | Total |
| Modula- | | | | | | | | En- |
| tion | Potential Modulations of Second MCS | | | | | | | tries |
| BPSK | BPSK | | | | | | | 1 |
| QPSK | BPSK | QPSK | | | | | | 2 |
| 16- | BPSK | QPSK | 16- | | | | | 3 |
| QAM | | | QAM | | | | | |
| 64- | BPSK | QPSK | 16- | 64- | | | | 4 |
| QAM | | | QAM | QAM | | | | |
| 256- | BPSK | QPSK | 16- | 64- | 256- | | | 5 |
| QAM | | | QAM | QAM | QAM | | | |
| 1024- | BPSK | QPSK | 16- | 64- | 256- | 1024- | | 6 |
| QAM | | | QAM | QAM | QAM | QAM | | |
| 4096- | BPSK | QPSK | 16- | 64- | 256- | 1024- | 4096- | 7 |
| QAM | | | QAM | QAM | QAM | QAM | QAM | |

In one example, a combination of two different modulations in Table 3 may indicate an unequal MCS assignment of two different MCSs for two respective spatial streams.

In one example, a combination of the same two modulations in Table 3 may indicate an equal MCS assignment of the same MCS for two spatial streams.

For example, as shown in line 5 of Table 3, UMCS subfield 404 may be set to indicate that the modulations of the first MCS and the second MCS are both 256-QAM. Accordingly, this setting may indicate an assignment of equal MCS, for example, as the first MCS and the second MCS share the same modulation and the same coding rate.

For example, as shown in line 6 of Table 3, UMCS subfield 404 may be set to indicate a 1024-QAM modulation for the first MCS and a 16-QAM for the second MCS. Accordingly, this setting may indicate an assignment of unequal MCS, for example, as the first MCS and the second MCS have different modulations with the same coding rate.

In some demonstrative aspects, as shown in Table 3, there may be a total of 28 possible different modulation combinations.

In some demonstrative aspects, there may be 4 different coding rates, for example, including coding rates of 1/2, 2/3, 3/4, and 5/6.

In some demonstrative aspects, there may be up to 4×28=112 different MCS combinations of two MCSs.

In some demonstrative aspects, configuring the UMCS subfield 404 to have a size of 7 bits may provide a technical solution to support up to 128 UEM values (indexes) corresponding to up to 128 different MCS combinations. Accordingly, configuring UMCS subfield 404 to include a 7-bit UEM value may be sufficient to support all possible 112 MCS combinations.

Referring back to FIG. 2, in some demonstrative aspects, UMCS subfield 204 may be configured according to a UMCS subfield design, which includes a coding-rate value and a modulation value, e.g., as described below.

In some demonstrative aspects, UMCS subfield 204 may be configured to utilize a first plurality of bits, for example, 2 bits, e.g., the first 2 bits of UMCS subfield 204, to represent a coding-rate value, which may indicate a same coding rate for both the first MCS and the second MCS of for the user, e.g., as described below.

In some demonstrative aspects, UMCS subfield 204 may be configured to utilize a first plurality of bits, for example, 5 bits, e.g., the last 5 bits of UMCS subfield 204, to represent a modulation value, which may indicate a combination of a modulation of the first MCS and a modulation of the second MCS, e.g., as described below.

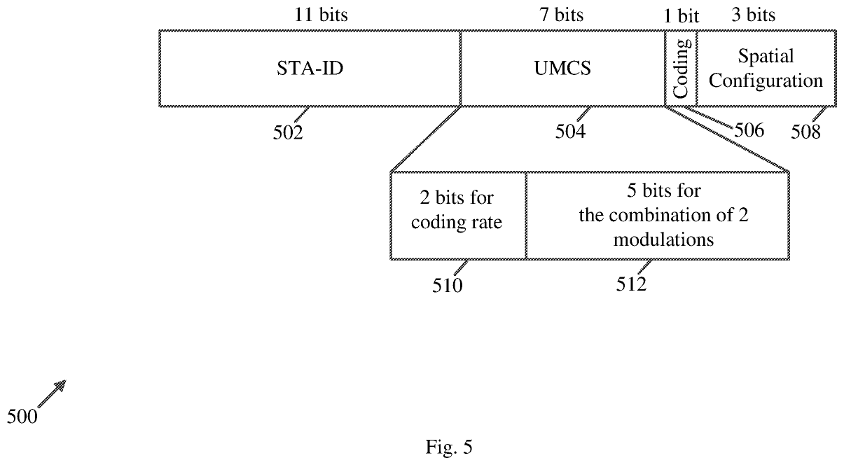

Reference is made to FIG. 5, which schematically illustrates a format of a user specific field 500, in accordance with some demonstrative aspects.

For example, user specific field 500 may include a user field format, which may be included in a SIG field of a PPDU.

For example, user specific field 500 may include a user field format, which may be configured to carry information for a user of a plurality of users in an MU-MIMO allocation.

For example, as shown in FIG. 5, user specific field 500 may have a bit size of 22 bits.

In some demonstrative aspects, one or more subfields of user specific field 200 (FIG. 2) may be configured according to one or more subfields of user specific field 500.

For example, device 102 (FIG. 1) may be configured to generate, process, and/or transmit a PPDU including a SIG field, which may include user specific field 500, for example, to provide user-specific information corresponding to a user of a plurality of users in a MU-MIMO allocation.

For example, device 140 (FIG. 1) and/or device 160 (FIG. 1) may be configured to receive and/or process a PPDU including a SIG field, which may include user specific field 500, for example, to identify user-specific information corresponding to a user of the plurality of users in the MU-MIMO allocation.

In some demonstrative aspects, as shown in FIG. 5, user specific field 500 may include a STA-ID field 502 to identify the user to which the user specific field 500 corresponds.

In some demonstrative aspects, as shown in FIG. 5, user specific field 500 may include a UMCS subfield 504, for example, after the STA-ID field 502.

In some demonstrative aspects, UMCS subfield 504 may be configured to indicate an assignment of a plurality of MCSs for the user identified by the STA-ID field 502.

In some demonstrative aspects, as shown in FIG. 5, user specific field 500 may include a spatial configuration subfield 508, for example, after the UMCS subfield 504.

In some demonstrative aspects, spatial configuration subfield 508 may be configured to indicate a number of spatial streams for the user and a total number of spatial streams in the MU-MIMO allocation.

In some demonstrative aspects, as shown in FIG. 5, spatial configuration subfield 508 may have a size of 3 bits.

In some demonstrative aspects, spatial configuration subfield 508 may be encoded, for example, according to Table 1, e.g., as described above.

In some demonstrative aspects, as shown in FIG. 5, user specific field 500 may include a coding subfield 506, for example, between the UMCS subfield 504 and the spatial configuration subfield 508.

In some demonstrative aspects, as shown in FIG. 5, UMCS subfield 504 may have a size of 7 bits.

In some demonstrative aspects, UMCS subfield 504 may include a coding-rate value 510, e.g., represented by 2 bits of UMCS subfield 504, which may be configured to indicate a same coding rate for both a first MCS and a second MCS assigned to the user identified by the identified by the STA-ID field 502.

In some demonstrative aspects, UMCS subfield 504 may include a modulation value 512, e.g., represented by 5 bits of UMCS subfield 504, which may be configured to indicate a modulation of the first MCS and a modulation of the second MCS for the user, e.g., as described below.

For example, the first 2 bits of UMCS subfield 504 may be configured to indicate the coding rate to be shared by both the first MCS and the second MCS for the user.

In some demonstrative aspects, the modulation value 512 may be configured to indicate both the modulation of the first MCS and the modulation of the second MCS, for example, based on a predefined mapping of a plurality of predefined modulation values to a plurality of predefined combinations of first and second modulations.

For example, the remaining 5 bits of UMCS subfield 504 may be configured to indicate the combination of two modulations, e.g., a modulation of the first MCS and a modulation of the second MCS.

For example, a plurality of possible coding rates for the first and second MCSs may include four different coding rates. According to this example, the first 2 bits of UMCS subfield 504 may be sufficient to indicate the coding-rate value 510 covering indexes of the four possible coding rates.

For example, a plurality of possible combinations of the modulation values for the first and second MCSs may include 28 possible modulation combinations, e.g., given a coding rate, for example, as described above with reference to Table 3.

For example, configuring the modulation value 512 to have a size of 5 bits may provide a technical solution to support up to 32 modulation combination indexes. Accordingly, configuring modulation value 512 to have a size of 5 bits may be sufficient to support all possible 28 modulation combinations.

For example, by reading all 7 bits of UMCS subfield 504, the user may be able to obtain a coding rate for the user, for example, through the coding-rate value 510 represented by the first 2 bits 510 of UMCS subfield 504; and may be able to obtain two modulations of two MCSs for the user, for example, through the modulation value 512 represented by the remaining 5 bits of UMCS subfield 504.

Referring back to FIG. 2, in some demonstrative aspects, UMCS subfield 204 may be configured according to a UMCS subfield design, which may be configured to indicate an assignment of up to two MCSs over up to four spatial streams per user, e.g., as described below.

In some demonstrative aspects, for example, the size of the spatial configuration subfield 208 may be reduced from 6 bits, e.g., to 3 bits, for example, in case of up to two spatial streams with two MCSs per user, e.g., as described above. For example, a 3-bit spatial configuration subfield may be utilized to indicate up to two spatial streams per user, e.g., as described above.

In some demonstrative aspects, the 3 bits “saved” by reducing the size of the spatial configuration subfield 208 may be combined with 4 bits from the MCS subfield, for example, to define a 7-bit UMCS subfield 204, e.g., as described above. For example, the 7-bit UMCS subfield 204 may indicate an assignment of up to two MCSs per user, e.g., as described above.

In some demonstrative aspects, for example, in some use cases and/or implementations, the may be a need to support indication of more than two spatial streams, e.g., up to 4 spatial streams for each user, e.g., in order to preserve compatibility with the IEEE 802.11be Specification.

In some demonstrative aspects, the size of the spatial configuration subfield 208 may be reduced from 6 bits, e.g., to 4 bits, for example, in case up to four spatial streams with two MCSs per user are to be supported, e.g., as described below.

For example, 2 bits may be relocated from spatial configuration subfields to UEM information subfields, for example by shrinking the spatial configuration subfields from 6 bits to 4 bits.

In some demonstrative aspects, spatial configuration subfield 208 may be configured as a 4-bit spatial configuration subfield, for example, to indicate up to four spatial streams per user and up to eight spatial streams in total in the MU-MIMO allocation.

In some demonstrative aspects, spatial configuration subfield 208 may be configured according to a predefined spatial configuration subfield encoding, which may be configured to support an indication of up to four spatial streams per user and up to eight spatial streams in total, e.g., as described below.

For example, spatial configuration subfield 208 may be configured to indicate all possible spatial configurations of up to four spatial streams per user and up to eight spatial streams in total, e.g., as follows:

TABLE 4

| | | Nₛₛ | Nₛₛ | Nₛₛ | Nₛₛ | Nₛₛ | Nₛₛ | Nₛₛ | Nₛₛ | Total | Total |
|---|---|---|---|---|---|---|---|---|---|---|---|
| Nᵤₛₑᵣ | B5 . . . B0 | [1] | [2] | [3] | [4] | [5] | [6] | [7] | [8] | Nₛₛ | entries |
| 2 | 0000- | 1-4 | 1 | | | | | | | 2-5 | 10 |
| | 0011 | | | | | | | | | | |
| | 0100- | 2-4 | 2 | | | | | | | 4-6 | |
| | 0110 | | | | | | | | | | |
| | 0111- | 3-4 | 3 | | | | | | | 6-7 | |
| | 1000 | | | | | | | | | | |
| | 1001 | 4 | 4 | | | | | | | 8 | |
| 3 | 0000- | 1-4 | 1 | 1 | | | | | | 3-6 | 13 |
| | 0011 | | | | | | | | | | |
| | 0100- | 2-4 | 2 | 1 | | | | | | 5-7 | |
| | 0110 | | | | | | | | | | |
| | 0111- | 3-4 | 3 | 1 | | | | | | 7-8 | |
| | 1000 | | | | | | | | | | |
| | 1001- | 2-4 | 2 | 2 | | | | | | 6-8 | |
| | 1011 | | | | | | | | | | |
| | 1100 | 3 | 3 | 2 | | | | | | 8 | |
| 4 | 0000- | 1-4 | 1 | 1 | 1 | | | | | 4-7 | 11 |
| | 0011 | | | | | | | | | | |
| | 0100- | 2-4 | 2 | 1 | 1 | | | | | 6-8 | |
| | 0110 | | | | | | | | | | |
| | 0111 | 3 | 3 | 1 | 1 | | | | | 8 | |
| | 1000- | 2-3 | 2 | 2 | 1 | | | | | 7-8 | |
| | 1001 | | | | | | | | | | |
| | 1010 | 2 | 2 | 2 | 2 | | | | | 8 | |
| 5 | 0000- | 1-4 | 1 | 1 | 1 | 1 | | | | 5-8 | 7 |
| | 0011 | | | | | | | | | | |
| | 0100- | 2-3 | 2 | 1 | 1 | 1 | | | | 7-8 | |
| | 0101 | | | | | | | | | | |
| | 0110 | 2 | 2 | 2 | 1 | 1 | | | | 8 | |
| 6 | 0000- | 1-3 | 1 | 1 | 1 | 1 | 1 | | | 6-8 | 4 |
| | 0010 | | | | | | | | | | |
| | 0011 | 2 | 2 | 1 | 1 | 1 | 1 | | | 8 | |
| 7 | 0000- | 1-2 | 1 | 1 | 1 | 1 | 1 | 1 | | 7-8 | 2 |
| | 0001 | | | | | | | | | | |
| 8 | 0000 | 1 | 1 | 1 | 1 | 1 | 1 | 1 | 1 | 8 | 1 |

For example, as shown in Table 4, there may be a maximum total of 13 entries, for example, when a number of users is equal to 3, e.g., Nᵤₛₑᵣ=3. According to this example, a 4-bit spatial configuration subfield 208 may be sufficient to indicate all possible spatial configurations of up to four spatial streams per user and up to eight spatial streams in total.

For example, configuring the spatial configuration subfield 208 to have a size of 4 bits may “free up” 2 bits, which may be used by UMCS subfield 204, e.g., as described below.

In some demonstrative aspects, UMCS subfield 204 may be configured to have size of 6 bits, which may be used to signal information of two MCSs. For example, the 6 bits may include the first 4 bits from the MCS subfield and the 2 bits relocated from the spatial configuration subfield.

In some demonstrative aspects, in some use cases, scenarios, and/or implementations, there may be a need to use 7 bits, for example, to represent all possible combinations of two MCSs per user, e.g., as described above.

In some demonstrative aspects, an additional bit may be implemented, e.g., in addition to the 6 bits of UMCS subfield 204, for example, in order to provide a technical solution to support signaling 7-bit UEM information, for example, to support all possible combinations of two MCSs per user, e.g., as described below.

In some demonstrative aspects, an extra bit may be relocated from the coding subfield 208.

For example, example, coding subfield 208 may be excluded from user specific field 200, e.g., as described below.

For example, a coding subfield may be configured to indicate a Low-Density Parity Check (LDPC) or Binary Convolutional Code (BCC), which may be used in a data field of a PPDU, e.g., in accordance with an IEEE 802.11 Specification.

In some demonstrative aspects, in some use cases, scenarios, and/or implementations, e.g., in accordance with the IEEE 802.11be Specification and/or derivatives thereof, only one encoding scheme, e.g., LDPC, may be applied to transmit data. Accordingly, the coding subfield may be not necessary, for example, as only LDPC is applied.

In some demonstrative aspects, 1 bit may be relocated from coding subfields used in transmissions of Unequal MCS information to UEM information subfields.

In some demonstrative aspects, an additional bit may be added to the user specific field 200, for example, to support signaling of the Unequal MCS information. For example, a length of the user specific field 200 may be increased from 22 bits to 23 bits.

In some demonstrative aspects, UMCS subfield 204 may be configured to have size of 6 bits, which may be configured to support signaling of the UEM information, for example, while maintaining the bit size of 22 bits for user specific field 200, e.g., as described below.

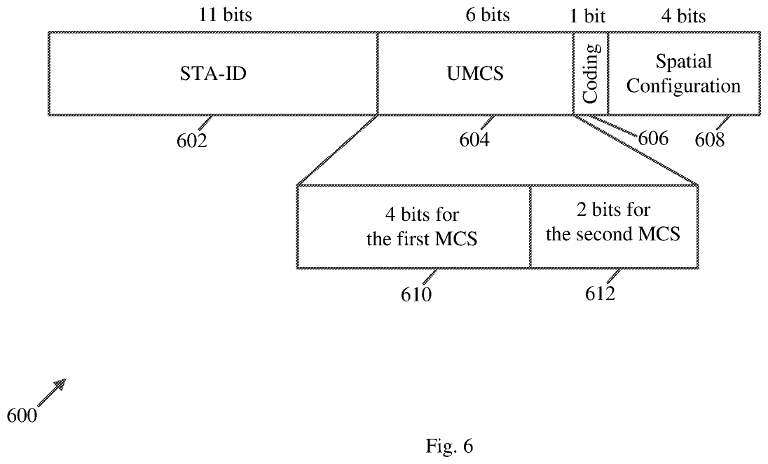

Reference is made to FIG. 6, which schematically illustrates a format of a user specific field 600, in accordance with some demonstrative aspects.

For example, user specific field 600 may include a user field format, which may be included in a SIG field of a PPDU.

For example, user specific field 600 may include a user field format, which may be configured to carry information for a user of a plurality of users in an MU-MIMO allocation.

For example, as shown in FIG. 6, user specific field 600 may have a bit size of 22 bits.

In some demonstrative aspects, one or more subfields of user specific field 200 (FIG. 2) may be configured according to one or more subfields of user specific field 600.

For example, device 102 (FIG. 1) may be configured to generate, process, and/or transmit a PPDU including a SIG field, which may include user specific field 600, for example, to provide user-specific information corresponding to a user of a plurality of users in a MU-MIMO allocation.

For example, device 140 (FIG. 1) and/or device 160 (FIG. 1) may be configured to receive and/or process a PPDU including a SIG field, which may include user specific field 600, for example, to identify user-specific information corresponding to a user of the plurality of users in the MU-MIMO allocation.

In some demonstrative aspects, as shown in FIG. 6, user specific field 600 may include a STA-ID field 602 to identify the user to which the user specific field 600 corresponds.

In some demonstrative aspects, as shown in FIG. 6, user specific field 600 may include a UMCS subfield 604, for example, after the STA-ID field 602.

In some demonstrative aspects, UMCS subfield 604 may be configured to indicate an assignment of a plurality of MCSs for the user identified by the STA-ID field 602.

In some demonstrative aspects, as shown in FIG. 6, user specific field 500 may include a spatial configuration subfield 608, for example, after the UMCS subfield 504.

In some demonstrative aspects, spatial configuration subfield 608 may be configured to indicate a number of spatial streams for the user and a total number of spatial streams in the MU-MIMO allocation.

In some demonstrative aspects, as shown in FIG. 6, spatial configuration subfield 608 may have a size of 4 bits.

In some demonstrative aspects, spatial configuration subfield 608 may be encoded, for example, according to Table 4, e.g., as described above.

In some demonstrative aspects, as shown in FIG. 6, user specific field 600 may include a coding subfield 606, for example, between the UMCS subfield 604 and the spatial configuration subfield 608.

In some demonstrative aspects, as shown in FIG. 6, UMCS subfield 604 may have a size of 6 bits.

For example, spatial configuration subfield 608 may be shrunk from 6 bits to 4 bits, for example, to support relocating 2 bits to UMCS subfield 604, e.g., as described above.

In some demonstrative aspects, UMCS subfield 604 may include a first MCS value 610 to indicate a first MCS of the plurality of MCSs for the user, and a second MCS value 612 to indicate a second MCS for the user, e.g., as described below.

In some demonstrative aspects, as shown in FIG. 6, UMCS subfield 604 may include 4 bits, e.g., including 4 first bits of UMCS subfield 604, which may be configured to represent the first MCS value 610, e.g., to convey information of the first MCS or the user.

In some demonstrative aspects, as shown in FIG. 6, UMCS subfield 604 may include 2 bits, e.g., including the 2 remaining bits of UMCS subfield 604, which may be configured to represent the second MCS value 612.

In some demonstrative aspects, the second MCS value 612, e.g., as represented the last two bits of UMCS field 602, may be configured to indicate a difference between a modulation order of the first MCS and a modulation order of the second MCS, e.g., as described below.

In some demonstrative aspects, the first MCS value 612 may be configured to represent an index of the first MCS for the user, e.g., the MCS with the largest modulation order. For example, the index of the first MCS may be configured to indicate both modulation and coding rate information for the first MCS.

In some demonstrative aspects, unequal MCSs of a user may share the same coding rate. For example, the unequal MCSs for the user may defer by their modulations, e.g., in accordance with an IEEE 802.11be Specification.

In some demonstrative aspects, the second MCS value 612, e.g., as represented the last two bits of UMCS field 604, may be utilized to indicate a modulation order deduction of the second MCS, for example, compared to the first MCS, e.g., rather than the MCS index of the second MCS.

In some demonstrative aspects, the second MCS value 612, e.g., as represented the last two bits of UMCS field 604, may be capable of supporting an indication of zero orders of deduction, 1 order of deduction, two orders of deduction, or three orders of deduction, e.g., of the modulation of the second MCS relative to the modulation of the first MCS.

For example, the second MCS value 612, e.g., as represented the last two bits of UMCS field 604, may be capable of supporting an indication of a plurality of predefined combinations of first and second MCSs, for example, having up to 3 orders of modulation reductions, e.g., as follows:

TABLE 5

| | Last 2 Bits of a UMCS Subfield | | | |
|---|---|---|---|---|
| First MCS's | 00 | 01 | 10 | 11 |
| Modulation | Second MCS's Modulation | | | |
| BPSK | BPSK | | | |
| QPSK | QPSK | BPSK | | |
| 16-QAM | 16-QAM | QPSK | BPSK | |
| 64-QAM | 64-QAM | 16-QAM | QPSK | BPSK |
| 256-QAM | 256-QAM | 64-QAM | 16-QAM | QPSK |
| 1024-QAM | 1024-QAM | 256-QAM | 64-QAM | 16-QAM |
| 4096-QAM | 4096-QAM | 1024-QAM | 256-QAM | 64-QAM |

In one example, a combination of two different modulations in Table 5 may indicate an unequal MCS assignment of two different MCSs for two respective spatial streams.

In one example, a combination of the same two modulations in Table 5 may indicate an equal MCS assignment of the same MCS for two spatial streams.

For example, as shown in line 6 of Table 5, when setting the first MCS value 610 to indicate the first MCS having a 1024-QAM modulation, the second MCS value 612 may be set to the values “00”, “01”, “10” or “11”, for example, to indicate the second MCS having a 1024-QAM modulation, a 256-QAM modulation, a 64-QAM modulation, or a 16-QAM modulation.

For example, as shown in Table 5, modulation order deductions between the first MCS and the second MCS may satisfy most cases, e.g., as most use cases may utilize unequal MCSs with a modulation order deduction lower than or equal to 3 orders.

In some demonstrative aspects, for example, in some implementations, scenarios, use cases, and/or deployments, the modulation order deduction between the first MCS and the second MCS may be higher than 3 orders.

In some demonstrative aspects, for example, in case of a modulation order deduction between the first MCS and the second MCS that is higher than 3 orders, a modulation of the second MCS may be adjusted to be 3 orders lower than a modulation of the first MCS.

For example, if the modulation of the first MCS is 1024-QAM, while an ideal modulation of the second MCS is QPSK, the modulation of the second MCS may be adjusted to 16-QAM, which is 3 orders lower than the modulation of the first MCS.

For example, the adjustment of the modulation of the second MCS may have limited effects on throughput performance. For example, if the modulation of the first MCS is 3 or more orders higher than the modulation of the second MCS, the first MCS may be dominant, e.g., absolutely dominant, to throughput performance, while the second MCS may have a limited impact on throughput performance.

In some demonstrative aspects, 6 bits of a UMCS subfield, e.g., UMCS subfield 604, may be used jointly for two or more spatial streams.

For example, an MCS table with up to 64 MCS entries may be built. For example, entries of the MCS table may include the most useful MCS combinations for both equal and unequal MCSs. For example, the 6 MCS bits of the UMCS subfield may indicate which MCS combination is to be used.

In some demonstrative aspects, UMCS subfield 604 may be configured to include a UEM value, which may be configured to indicate both the first MCS and the second MCS.

In some demonstrative aspects, the UEM value may be configured to indicate both the first MCS and the second MCS based on a predefined mapping of a plurality of predefined UEM values, e.g., up to 64 values, to a plurality of predefined combinations, e.g., up to 64 combinations, of first and second MCSs.

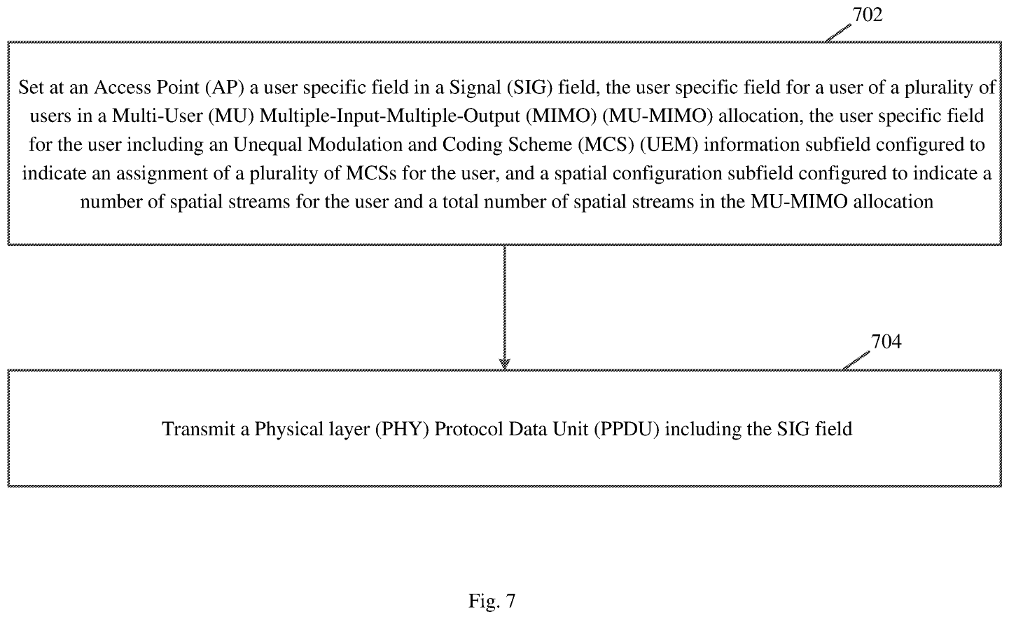

Reference is made to FIG. 7, which schematically illustrates a method of communicating UEM information, in accordance with some demonstrative aspects. For example, one or more of the operations of the method of FIG. 7 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 702, the method may include setting at an AP a user specific field in a SIG field. For example, the user specific field may be configured for a user of a plurality of users in a MU-MIMO allocation. For example, the user specific field may include an UEM information subfield configured to indicate an assignment of a plurality of MCSs for the user. For example, the user specific field may include a spatial configuration subfield configured to indicate a number of spatial streams for the user and a total number of spatial streams in the MU-MIMO allocation. For example, controller 124 (FIG. 1) may be configured to cause, trigger, and/or control device 102 (FIG. 1) to set the user specific field 200 (FIG. 2) in the SIG field, e.g., as described above.

As indicated at block 704, the method may include transmitting a PPDU including the SIG field. For example, controller 124 (FIG. 1) may be configured to cause, trigger, and/or control device 102 (FIG. 1) to transmit the PPDU, which includes the SIG field including the user specific field 200 (FIG. 2), e.g., as described above.

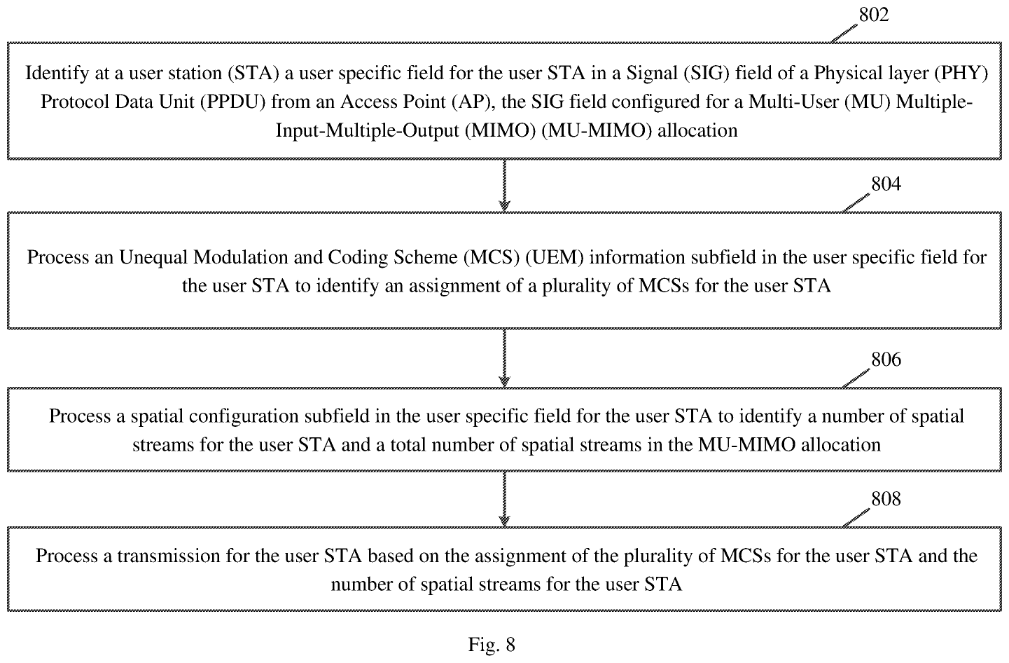

Reference is made to FIG. 8, which schematically illustrates a method of communicating UEM information, in accordance with some demonstrative aspects. For example, one or more of the operations of the method of FIG. 8 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 802, the method may include identifying at a user STA a user specific field for the user STA in a SIG field of a PPDU from an AP. For example, the SIG field may be configured for an MU-MIMO allocation. For example, controller 154 (FIG. 1) may be configured to cause, trigger, and/or control device 140 (FIG. 1) to identify the user specific field 200 (FIG. 2) for device 140 (FIG. 1) in the SIG field of the PPDU from the AP, e.g., as described above.

As indicated at block 804, the method may include processing a UEM information subfield in the user specific field for the user STA to identify an assignment of a plurality of MCSs for the user STA. For example, controller 154 (FIG. 1) may be configured to cause, trigger, and/or control device 140 (FIG. 1) to process the UEM information subfield 204 (FIG. 2) in the user specific field 200 (FIG. 2) for device 140 (FIG. 1) to identify the assignment of the plurality of MCSs for device 140 (FIG. 1), e.g., as described above.

As indicated at block 806, the method may include processing a spatial configuration subfield in the user specific field for the user STA to identify a number of spatial streams for the user STA and a total number of spatial streams in the MU-MIMO allocation. For example, controller 154 (FIG. 1) may be configured to cause, trigger, and/or control device 140 (FIG. 1) to process the spatial configuration subfield 208 (FIG. 2) in the user specific field 200 (FIG. 2) for device 140 (FIG. 1) to identify the number of spatial streams for device 140 (FIG. 1) and the total number of spatial streams in the MU-MIMO allocation, e.g., as described above.

As indicated at block 806, the method may include processing a transmission for the user STA based on the assignment of the plurality of MCSs for the user STA and the number of spatial streams for the user STA. For example, controller 154 (FIG. 1) may be configured to cause, trigger, and/or control device 140 (FIG. 1) to process a transmission for device 140 (FIG. 1) based on the assignment of the plurality of MCSs for device 140 (FIG. 1) and the number of spatial streams for device 140 (FIG. 1), e.g., as described above.

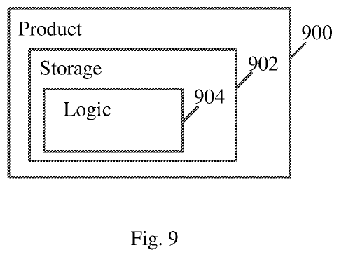

Reference is made to FIG. 9, which schematically illustrates a product of manufacture 900, in accordance with some demonstrative aspects. Product 900 may include one or more tangible computer-readable (“machine-readable”) non-transitory storage media 902, which may include computer-executable instructions, e.g., implemented by logic 904, operable to, when executed by at least one computer processor, enable the at least one computer processor to implement one or more operations at device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1); to cause device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1) to perform, trigger and/or implement one or more operations and/or functionalities; and/or to perform, trigger and/or implement one or more operations and/or functionalities described with reference to the FIGS. 1, 2, 3, 4, 5, 6, 7, and/or 8, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 900 and/or machine readable storage media 902 may include one or more types of computer-readable storage media capable of storing data, including volatile memory, non-volatile memory, removable or non-removable memory, erasable or non-erasable memory, writeable or re-writeable memory, and the like. For example, machine readable storage media 902 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 904 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 904 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising logic and circuitry configured to cause an Access Point (AP) to set a user specific field in a Signal (SIG) field, the user specific field for a user of a plurality of users in a Multi-User (MU) Multiple-Input-Multiple-Output (MIMO) (MU-MIMO) allocation, the user specific field for the user comprising an Unequal Modulation and Coding Scheme (MCS) (UEM) information subfield configured to indicate an assignment of a plurality of MCSs for the user; and a spatial configuration subfield configured to indicate a number of spatial streams for the user and a total number of spatial streams in the MU-MIMO allocation; and transmit a Physical layer (PHY) Protocol Data Unit (PPDU) comprising the SIG field.

Example 2 includes the subject matter of Example 1, and optionally, wherein the UEM information subfield comprises a first MCS value to indicate a first MCS of the plurality of MCSs, and a second MCS value to indicate a second MCS of the plurality of MCSs.

Example 3 includes the subject matter of Example 2, and optionally, wherein the second MCS value is configured to indicate the second MCS based on the first MCS value.

Example 4 includes the subject matter of Example 3, and optionally, wherein the second MCS value is configured to indicate the second MCS based on a predefined mapping of a plurality of predefined second MCSs to a plurality of combinations between a plurality of predefined first MCS values and a plurality of predefined second MCS values.

Example 5 includes the subject matter of Example 3, and optionally, wherein the second MCS value is configured to indicate a difference between a modulation order of the first MCS and a modulation order of the second MCS.

Example 6 includes the subject matter of Example 2 or 3, and optionally, wherein the second MCS value is configured to indicate a modulation order of the second MCS.

Example 7 includes the subject matter of any one of Examples 2-6, and optionally, wherein the first MCS has a higher modulation order than the second MCS.

Example 8 includes the subject matter of any one of Examples 2-7, and optionally, wherein the first MCS and the second MCS have a same coding rate.

Example 9 includes the subject matter of any one of Examples 2-8, and optionally, wherein the first MCS value comprises an MCS index of the first MCS.

Example 10 includes the subject matter of any one of Examples 2-9, and optionally, wherein the first MCS value has a size of 4 bits.

Example 11 includes the subject matter of any one of Examples 2-10, and optionally, wherein the second MCS value has a size of up to 4 bits.

Example 12 includes the subject matter of any one of Examples 2-11, and optionally, wherein the second MCS value has a size of 3 bits.

Example 13 includes the subject matter of any one of Examples 2-12, and optionally, wherein a difference between a modulation order of the first MCS and a modulation order of the second MCS is more than 3.

Example 14 includes the subject matter of Example 1, and optionally, wherein the UEM information subfield comprises a UEM value configured to indicate both the first MCS and the second MCS.

Example 15 includes the subject matter of Example 14, and optionally, wherein the UEM value is configured to indicate both the first MCS and the second MCS based on a predefined mapping of a plurality of predefined UEM values to a plurality of predefined combinations of first and second MCSs.

Example 16 includes the subject matter of Example 1, and optionally, wherein the UEM information subfield comprises a coding-rate value and a modulation value, the coding rate value configured to indicate a same coding rate for both the first MCS and the second MCS, the modulation value configured to indicate a modulation of the first MCS and a modulation of the second MCS.

Example 17 includes the subject matter of Example 16, and optionally, wherein the modulation value is configured to indicate both the modulation of the first MCS and the modulation of the second MCS based on a predefined mapping of a plurality of predefined modulation values to a plurality of predefined combinations of first and second modulations.

Example 18 includes the subject matter of any one of Examples 1-17, and optionally, wherein the spatial configuration subfield has a size of no more than 4 bits.

Example 19 includes the subject matter of any one of Examples 1-18, and optionally, wherein the spatial configuration subfield has a size of 4 bits.

Example 20 includes the subject matter of any one of Examples 1-19, and optionally, wherein the spatial configuration subfield has a size of 3 bits.

Example 21 includes the subject matter of any one of Examples 1-20, and optionally, wherein the UEM information subfield has a size of at least 6 bits.

Example 22 includes the subject matter of any one of Examples 1-21, and optionally, wherein the UEM information subfield has a size of 6 bits.

Example 23 includes the subject matter of any one of Examples 1-22, and optionally, wherein the UEM information subfield has a size of 7 bits.

Example 24 includes the subject matter of any one of Examples 1-23, and optionally, wherein the apparatus is configured to cause the AP to set a value of the spatial configuration subfield according to a predefined spatial configuration subfield encoding configured to support an indication of up to two spatial streams per user and up to eight spatial streams in total.

Example 25 includes the subject matter of any one of Examples 1-23, and optionally, wherein the apparatus is configured to cause the AP to set a value of the spatial configuration subfield according to a predefined spatial configuration subfield encoding configured to support an indication of up to four spatial streams per user and up to eight spatial streams in total.

Example 26 includes the subject matter of any one of Examples 1-25, and optionally, wherein the user specific field for the user is configured according to a user specific field format comprising a station (STA) identifier (ID) (STA-ID) field to identify the user, the UEM information subfield after the STA-ID field, and the spatial configuration subfield after the UEM information subfield.

Example 27 includes the subject matter of Example 26, and optionally, wherein the user specific field format comprises a coding subfield between the UEM information subfield and the spatial configuration subfield.

Example 28 includes the subject matter of any one of Examples 1-27, and optionally, wherein the apparatus is configured to cause the AP to set in the SIG field a non-UEM user specific field for a non-UEM user of the plurality of users, wherein the non-UEM user specific field comprises an MCS information subfield configured to indicate an assignment of a single MCS to the non-UEM user.

Example 29 includes the subject matter of any one of Examples 1-28, and optionally, wherein the user specific field for the user has a bit size of 22 bits.

Example 30 includes the subject matter of any one of Examples 1-29, and optionally, wherein the SIG field comprises an Extremely High Throughput (EHT) SIG (EHT-SIG) field.

Example 31 includes the subject matter of any one of Examples 1-30, and optionally, wherein the PPDU comprises an Extremely High Throughput (EHT) PPDU.

Example 32 includes the subject matter of any one of Examples 1-31, and optionally, wherein the PPDU comprises an Ultra High Reliability (UHR) PPDU.

Example 33 includes the subject matter of any one of Examples 1-32, and optionally, comprising at least one radio to transmit the PPDU.

Example 34 includes the subject matter of Example 33, and optionally, comprising one or more antennas connected to the radio, and a processor to execute instructions of an operating system of the AP.

Example 35 includes an apparatus comprising logic and circuitry configured to cause a user station (STA) to identify a user specific field for the user STA in a Signal (SIG) field of a Physical layer (PHY) Protocol Data Unit (PPDU) from an Access Point (AP), the SIG field configured for a Multi-User (MU) Multiple-Input-Multiple-Output (MIMO) (MU-MIMO) allocation; process an Unequal Modulation and Coding Scheme (MCS) (UEM) information subfield in the user specific field for the user STA to identify an assignment of a plurality of MCSs for the user STA; process a spatial configuration subfield in the user specific field for the user STA to identify a number of spatial streams for the user STA and a total number of spatial streams in the MU-MIMO allocation; and process a transmission for the user STA based on the assignment of the plurality of MCSs for the user STA and the number of spatial streams for the user STA.

Example 36 includes the subject matter of Example 35, and optionally, wherein the UEM information subfield comprises a first MCS value to indicate a first MCS of the plurality of MCSs, and a second MCS value to indicate a second MCS of the plurality of MCSs.

Example 37 includes the subject matter of Example 36, and optionally, wherein the second MCS value is configured to indicate the second MCS based on the first MCS value.

Example 38 includes the subject matter of Example 37, and optionally, wherein the second MCS value is configured to indicate the second MCS based on a predefined mapping of a plurality of predefined second MCSs to a plurality of combinations between a plurality of predefined first MCS values and a plurality of predefined second MCS values.

Example 39 includes the subject matter of Example 37, and optionally, wherein the second MCS value is configured to indicate a difference between a modulation order of the first MCS and a modulation order of the second MCS.

Example 40 includes the subject matter of Example 36 or 37, and optionally, wherein the second MCS value is configured to indicate a modulation order of the second MCS.

Example 41 includes the subject matter of any one of Examples 36-40, and optionally, wherein the first MCS has a higher modulation order than the second MCS.

Example 42 includes the subject matter of any one of Examples 36-41, and optionally, wherein the first MCS and the second MCS have a same coding rate.

Example 43 includes the subject matter of any one of Examples 36-42, and optionally, wherein the first MCS value comprises an MCS index of the first MCS.

Example 44 includes the subject matter of any one of Examples 36-43, and optionally, wherein the first MCS value has a size of 4 bits.

Example 45 includes the subject matter of any one of Examples 36-44, and optionally, wherein the second MCS value has a size of up to 4 bits.

Example 46 includes the subject matter of any one of Examples 36-45, and optionally, wherein the second MCS value has a size of 3 bits.

Example 47 includes the subject matter of any one of Examples 36-46, and optionally, wherein a difference between a modulation order of the first MCS and a modulation order of the second MCS is more than 3.

Example 48 includes the subject matter of Example 35, and optionally, wherein the UEM information subfield comprises a UEM value configured to indicate both the first MCS and the second MCS.

Example 49 includes the subject matter of Example 48, and optionally, wherein the UEM value is configured to indicate both the first MCS and the second MCS based on a predefined mapping of a plurality of predefined UEM values to a plurality of predefined combinations of first and second MCSs.

Example 50 includes the subject matter of Example 35, and optionally, wherein the UEM information subfield comprises a coding-rate value and a modulation value, the coding rate value configured to indicate a same coding rate for both the first MCS and the second MCS, the modulation value configured to indicate a modulation of the first MCS and a modulation of the second MCS.

Example 51 includes the subject matter of Example 50, and optionally, wherein the modulation value is configured to indicate both the modulation of the first MCS and the modulation of the second MCS based on a predefined mapping of a plurality of predefined modulations values to a plurality of predefined combinations of first and second modulations.

Example 52 includes the subject matter of any one of Examples 35-51, and optionally, wherein the spatial configuration subfield has a size of no more than 4 bits.

Example 53 includes the subject matter of any one of Examples 35-52, and optionally, wherein the spatial configuration subfield has a size of 4 bits.

Example 54 includes the subject matter of any one of Examples 35-53, and optionally, wherein the spatial configuration subfield has a size of 3 bits.

Example 55 includes the subject matter of any one of Examples 35-54, and optionally, wherein the UEM information subfield has a size of at least 6 bits.

Example 56 includes the subject matter of any one of Examples 35-55, and optionally, wherein the UEM information subfield has a size of 6 bits.

Example 57 includes the subject matter of any one of Examples 35-56, and optionally, wherein the UEM information subfield has a size of 7 bits.

Example 58 includes the subject matter of any one of Examples 35-57, and optionally, wherein the apparatus is configured to cause the user STA to determine the number of spatial streams for the user STA by processing a value of the spatial configuration subfield according to a predefined spatial configuration subfield encoding configured to support an indication of up to two spatial streams per user and up to eight spatial streams in total.

Example 59 includes the subject matter of any one of Examples 35-57, and optionally, wherein the apparatus is configured to cause the user STA to determine the number of spatial streams for the user STA by processing a value of the spatial configuration subfield according to a predefined spatial configuration subfield encoding configured to support an indication of up to four spatial streams per user and up to eight spatial streams in total.

Example 60 includes the subject matter of any one of Examples 35-59, and optionally, wherein the user specific field for the user STA is configured according to a user specific field format comprising a station (STA) identifier (ID) (STA-ID) field to identify the user STA, the UEM information subfield after the STA-ID field, and the spatial configuration subfield after the UEM information subfield.

Example 61 includes the subject matter of Example 60, and optionally, wherein the user specific field format comprises a coding subfield between the UEM information subfield and the spatial configuration subfield.

Example 62 includes the subject matter of any one of Examples 35-61, and optionally, wherein the user-field for the user STA has a bit size of 22 bits.

Example 63 includes the subject matter of any one of Examples 35-62, and optionally, wherein the SIG field comprises an Extremely High Throughput (EHT) SIG (EHT-SIG) field.

Example 64 includes the subject matter of any one of Examples 35-63, and optionally, wherein the PPDU comprises an Extremely High Throughput (EHT) PPDU.

Example 65 includes the subject matter of any one of Examples 35-64, and optionally, wherein the PPDU comprises an Ultra High Reliability (UHR) PPDU.

Example 66 includes the subject matter of any one of Examples 35-65, and optionally, comprising at least one radio to transmit the PPDU.

Example 67 includes the subject matter of Example 66, and optionally, comprising one or more antennas connected to the radio, and a processor to execute instructions of an operating system of the user STA.

Example 68 includes a wireless communication device including the apparatus of any of Examples 1-67.

Example 69 includes a mobile device including the apparatus of any of Examples 1-67.

Example 70 includes an apparatus including means for executing any of the described operations of any of Examples 1-67.

Example 71 includes a product including one or more tangible computer-readable non-transitory storage media comprising instructions operable to, when executed by at least one processor, enable the at least one processor to cause a wireless communication device to perform any of the described operations of any of Examples 1-67.

Example 72 includes an apparatus including: a memory interface; and processing circuitry configured to: perform any of the described operations of any of Examples 1-67.

Example 73 includes a method including any of the described operations of any of Examples 1-67.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising logic and circuitry configured to cause an Access Point (AP) to:
set a user specific field in a Signal (SIG) field, the user specific field for a user of a plurality of users in a Multi-User (MU) Multiple-Input-Multiple-Output (MIMO) (MU-MIMO) allocation, the user specific field for the user comprising:
an Unequal Modulation and Coding Scheme (MCS) (UEM) information subfield configured to indicate an assignment of a plurality of MCSs for the user; and
a spatial configuration subfield configured to indicate a number of spatial streams for the user and a total number of spatial streams in the MU-MIMO allocation; and
transmit a Physical layer (PHY) Protocol Data Unit (PPDU) comprising the SIG field.

2. The apparatus of claim 1, wherein the UEM information subfield comprises a first MCS value to indicate a first MCS of the plurality of MCSs, and a second MCS value to indicate a second MCS of the plurality of MCSs.

3. The apparatus of claim 2, wherein the second MCS value is configured to indicate the second MCS based on the first MCS value.

4. The apparatus of claim 3, wherein the second MCS value is configured to indicate the second MCS based on a predefined mapping of a plurality of predefined second MCSs to a plurality of combinations between a plurality of predefined first MCS values and a plurality of predefined second MCS values.

5. The apparatus of claim 3, wherein the second MCS value is configured to indicate a difference between a modulation order of the first MCS and a modulation order of the second MCS.

6. The apparatus of claim 2, wherein the second MCS value is configured to indicate a modulation order of the second MCS.

7. The apparatus of claim 2, wherein the first MCS has a higher modulation order than the second MCS.

8. The apparatus of claim 2, wherein the first MCS value has a size of 4 bits.

9. The apparatus of claim 2, wherein the second MCS value has a size of up to 4 bits.

10. The apparatus of claim 1, wherein the UEM information subfield comprises a UEM value configured to indicate both the first MCS and the second MCS.

11. The apparatus of claim 10, wherein the UEM value is configured to indicate both the first MCS and the second MCS based on a predefined mapping of a plurality of predefined UEM values to a plurality of predefined combinations of first and second MCSs.

12. The apparatus of claim 1, wherein the UEM information subfield comprises a coding-rate value and a modulation value, the coding rate value configured to indicate a same coding rate for both the first MCS and the second MCS, the modulation value configured to indicate a modulation of the first MCS and a modulation of the second MCS.

13. The apparatus of claim 1, wherein the spatial configuration subfield has a size of no more than 4 bits.

14. The apparatus of claim 1, wherein the UEM information subfield has a size of at least 6 bits.

15. The apparatus of claim 1 configured to cause the AP to set a value of the spatial configuration subfield according to a predefined spatial configuration subfield encoding configured to support an indication of up to two spatial streams per user and up to eight spatial streams in total.

16. The apparatus of claim 1 configured to cause the AP to set a value of the spatial configuration subfield according to a predefined spatial configuration subfield encoding configured to support an indication of up to four spatial streams per user and up to eight spatial streams in total.

17. The apparatus of claim 1 comprising at least one radio to transmit the PPDU.

18. The apparatus of claim 17 comprising one or more antennas connected to the radio, and a processor to execute instructions of an operating system of the AP.

19. A product comprising one or more tangible computer-readable non-transitory storage media comprising instructions operable to, when executed by at least one processor, enable the at least one processor to cause an Access Point (AP) to:
set a user specific field in a Signal (SIG) field, the user specific field for a user of a plurality of users in a Multi-User (MU) Multiple-Input-Multiple-Output (MIMO) (MU-MIMO) allocation, the user specific field for the user comprising:
an Unequal Modulation and Coding Scheme (MCS) (UEM) information subfield configured to indicate an assignment of a plurality of MCSs for the user; and
a spatial configuration subfield configured to indicate a number of spatial streams for the user and a total number of spatial streams in the MU-MIMO allocation; and
transmit a Physical layer (PHY) Protocol Data Unit (PPDU) comprising the SIG field.

20. The product of claim 19, wherein the user-field for the user STA has a bit size of 22 bits.
